(19) United States
(12) Patent Application Publication
(10) Pub. No.: US 2025/0284816 A1
(43) Pub. Date: Sep. 11, 2025

(54) AUTOMATED ASSESSMENT OF SOFTWARE-AS-A-SERVICE PLATFORMS

(71) Applicant: Capital One Services LLC, McLean, VA (US)

(72) Inventors: Azhar HAMAYUN, Ashburn, VA (US); Rashique Mir MUSTAHSEEN, Falls Church, VA (US); Sreenarayan ASHOK KUMAR, Herndon, VA (US)

(21) Appl. No.: 18/597,552

(22) Filed: Mar. 6, 2024

(51) Int. Cl. G06F 21/57

(52) U.S. Cl. CPC G06F 21/577; G06F 2221/033

(57) ABSTRACT

In some implementations, a user device may transmit, to an assessment system, a request to onboard a software-as-a-service (SaaS) platform. The user device may receive, from the assessment system, a set of responses to a set of questions associated with the SaaS platform. The user device may further receive, from the assessment system, a report including a set of risk scores. The set of risk scores may be calculated from the set of responses (e.g., by the assessment system). The user device may transmit a command to onboard the SaaS platform based on the set of risk scores.

### BACKGROUND

Rather than host computer applications in-house or in a full cloud environment, many organizations are moving to software-as-a-service (SaaS) platforms. SaaS platforms may provide application programming interfaces (APIs) for organizations to use without the organizations having to maintain full cloud environments for the APIs. However, SaaS platforms may result in security risks to data.

### SUMMARY

Some implementations described herein relate to a system for automatically assessing a SaaS platform. The system may include one or more memories and one or more processors communicatively coupled to the one or more memories. The one or more processors may be configured to receive, from a user device, a request to onboard the SaaS platform. The one or more processors may be configured to generate, using a machine learning model, a form with a set of questions associated with the SaaS platform, wherein a portion of the form is populated with at least one suggested answer. The one or more processors may be configured to transmit, to an administrator device associated with the SaaS platform, a link to the form. The one or more processors may be configured to receive, from the administrator device, a set of responses to the set of questions in the form. The one or more processors may be configured to provide the set of responses to an assessment model, in order to receive a set of risk scores associated with the SaaS platform. The one or more processors may be configured to transmit, to the user device, a report including the set of risk scores. The one or more processors may be configured to monitor a configuration associated with the SaaS platform for a detected change. The one or more processors may be configured to transmit, to the administrator device, an additional question in response to the detected change. The one or more processors may be configured to receive, from the administrator device, an additional response to the additional question. The one or more processors may be configured to provide the additional response to the assessment model, in order to receive an updated set of risk scores associated with the SaaS platform. The one or more processors may be configured to transmit, to the user device, a report including the updated set of risk scores.

Some implementations described herein relate to a method of automatically assessing a SaaS platform. The method may include transmitting, from a user device and to an assessment system, a request to onboard the SaaS platform. The method may include receiving, from the assessment system and at the user device, a set of responses to a set of questions associated with the SaaS platform. The method may include receiving, from the assessment system and at the user device, a report including a set of risk scores, wherein the set of risk scores are calculated from the set of responses. The method may include transmitting, from the user device, a command to onboard the SaaS platform based on the set of risk scores.

Some implementations described herein relate to a non-transitory computer-readable medium that stores a set of instructions for automatically assessing a SaaS platform. The set of instructions, when executed by one or more processors of a device, may cause the device to receive, from an assessment system, a link to a form with a set of questions associated with the SaaS platform, wherein at least one subsequent question, in the set of questions of the form, is dynamically modified based on at least one answer to at least one preceding question in the set of questions. The set of instructions, when executed by one or more processors of the device, may cause the device to transmit, to the assessment system, a set of responses to the set of questions. The set of instructions, when executed by one or more processors of the device, may cause the device to receive, from the assessment system, an additional question in response to a detected change associated with the SaaS platform. The set of instructions, when executed by one or more processors of the device, may cause the device to transmit, to the assessment system, an additional response to the additional question.

### BRIEF DESCRIPTION OF THE DRAWINGS

FIGS. 1A-1D are diagrams of an example implementation relating to automated assessment of SaaS platforms, in accordance with some embodiments of the present disclosure.

FIGS. 2A-2D are diagrams of an example implementation relating to automatically updating assessments of SaaS platforms, in accordance with some embodiments of the present disclosure.

FIGS. 3A-3B are diagrams of example user interfaces (UIs) associated with an automated assessment of a SaaS platform, in accordance with some embodiments of the present disclosure.

FIGS. 4A-4B are diagrams of example UIs associated with a report including an assessment of a SaaS platform, in accordance with some embodiments of the present disclosure.

FIGS. 5A-5C are diagrams of example UIs associated with initiating assessment of a SaaS platform, in accordance with some embodiments of the present disclosure.

FIGS. 6A-6C are diagrams of example UIs associated with modifying an assessment of a SaaS platform, in accordance with some embodiments of the present disclosure.

FIGS. 7A-7B are diagrams of example UIs associated with a report including an assessment of a SaaS platform, in accordance with some embodiments of the present disclosure.

FIG. 8 is a diagram of an example environment in which systems and/or methods described herein may be implemented, in accordance with some embodiments of the present disclosure.

FIG. 9 is a diagram of example components of one or more devices of FIG. 8, in accordance with some embodiments of the present disclosure.

FIG. 10 is a flowchart of an example process relating to automated assessment of SaaS platforms, in accordance with some embodiments of the present disclosure.

FIG. 11 is a flowchart of an example process relating to initiating automated assessment of SaaS platforms, in accordance with some embodiments of the present disclosure.

FIG. 12 is a flowchart of an example process relating to responding for assessment of SaaS platforms, in accordance with some embodiments of the present disclosure.

### DETAILED DESCRIPTION

The following detailed description of example implementations refers to the accompanying drawings. The same reference numbers in different drawings may identify the same or similar elements.

One alternative to hosting computer applications in an in-house or in a full cloud environment is the use of a SaaS platform. SaaS platforms provide APIs that connect to existing endpoints and provide services without a host of the endpoints having to maintain full cloud environments for the APIs. Therefore, a SaaS platform may conserve power and processing resources for a client of the SaaS platform. However, SaaS platforms may result in security risks to data. For example, SaaS platforms may execute applications for different clients in a multi-tenant environment and thus create a risk of commingling data from the different clients. In another example, SaaS platforms may not apply data encryption (or may perform weak encryption) even though clients provide sensitive data to the SaaS platforms.

Assessing risks of a SaaS platform is essential before the SaaS platform is onboarded (e.g., connected to endpoints of a client). However, such assessment may include multiple communications between the client (e.g., users that work for the client) and a contact associated with the SaaS platform (e.g., an administrator of the SaaS platform). These communications increase network overhead. Additionally, re-assessing the SaaS platform periodically (and/or in response to changes) results in further communications between the client and the contact, which further increase network overhead.

Some implementations described herein enable automated assessment of a SaaS platform. In particular, a form may be automatically transmitted to an administrator device (associated with the SaaS platform) in response to a request to onboard the SaaS platform (e.g., from a user device of a user). Subsequent questions of the form may be dynamically modified based on answers to preceding questions. Additionally, or alternatively, a portion of the form is populated with suggested answers (e.g., using a machine learning model). As a result, network overhead is reduced because the dynamic and/or pre-populated form reduces an amount of communications between the user device and the administrator device.

Furthermore, some implementations described herein enable a machine learning model to calculate a set of risk scores based on answers in the form. Additionally, the SaaS platform may be monitored for changes, and new questions may be automatically transmitted to the administrator device when a change is detected. As a result, network overhead is further reduced because the change to the SaaS platform automatically triggers updated assessment, which reduces communications between the user device and the administrator device.

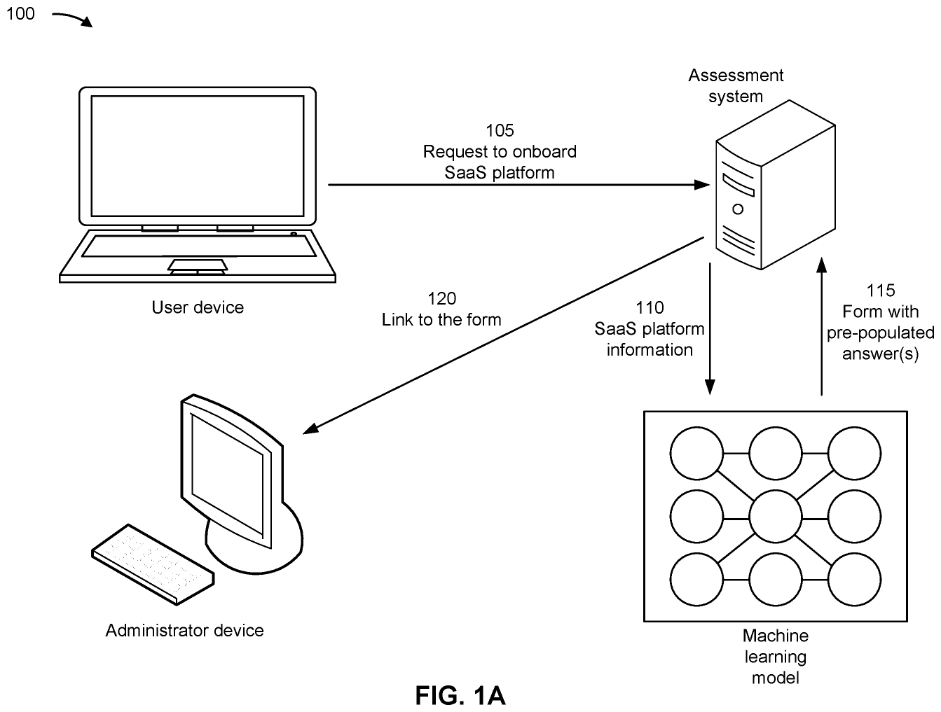

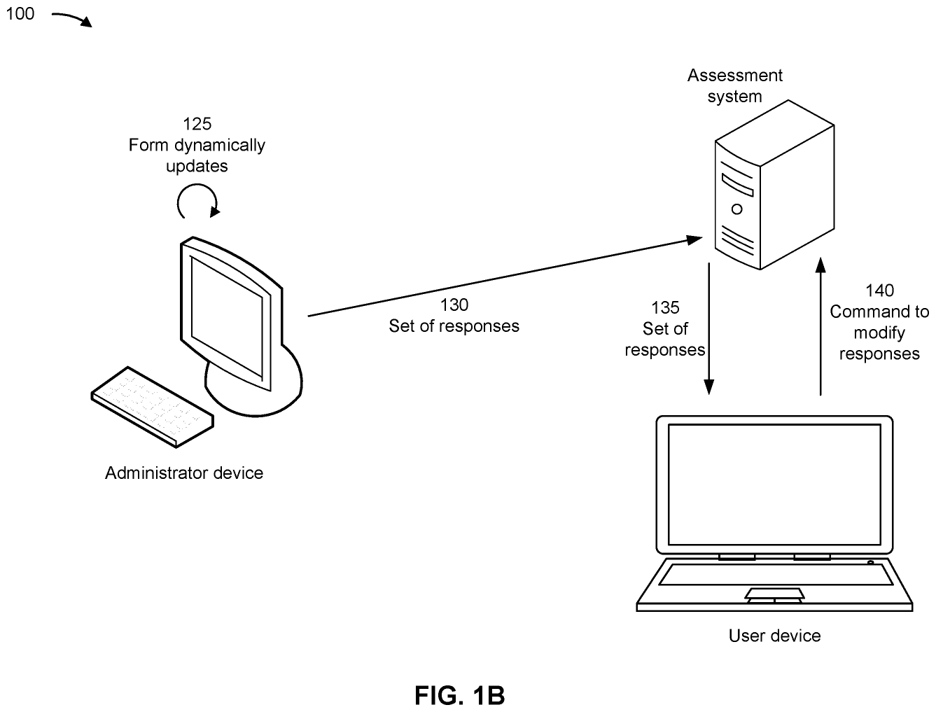

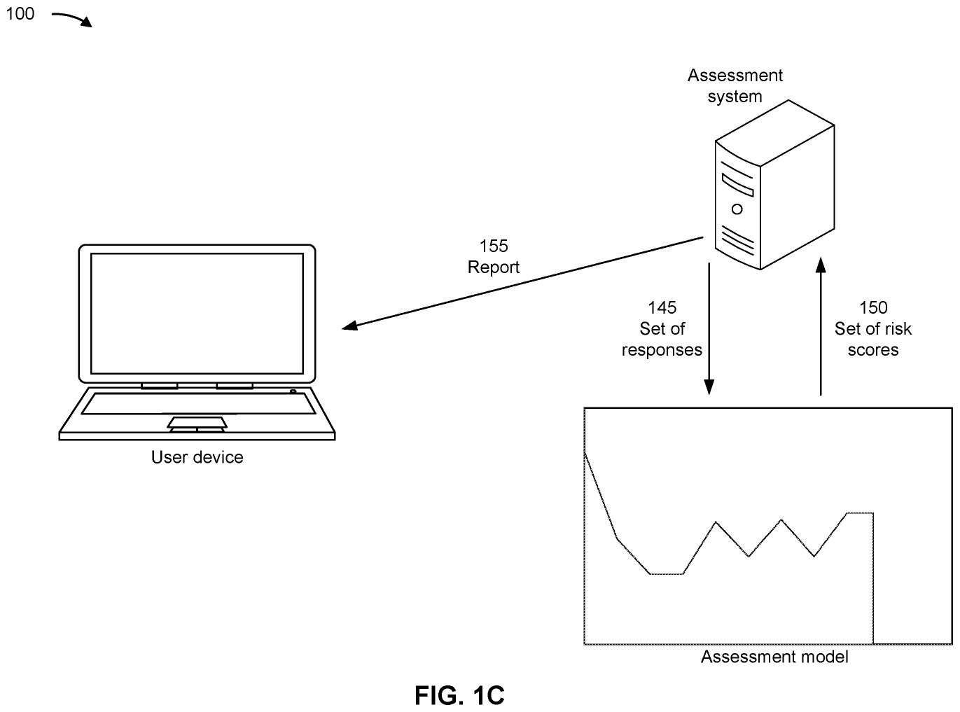

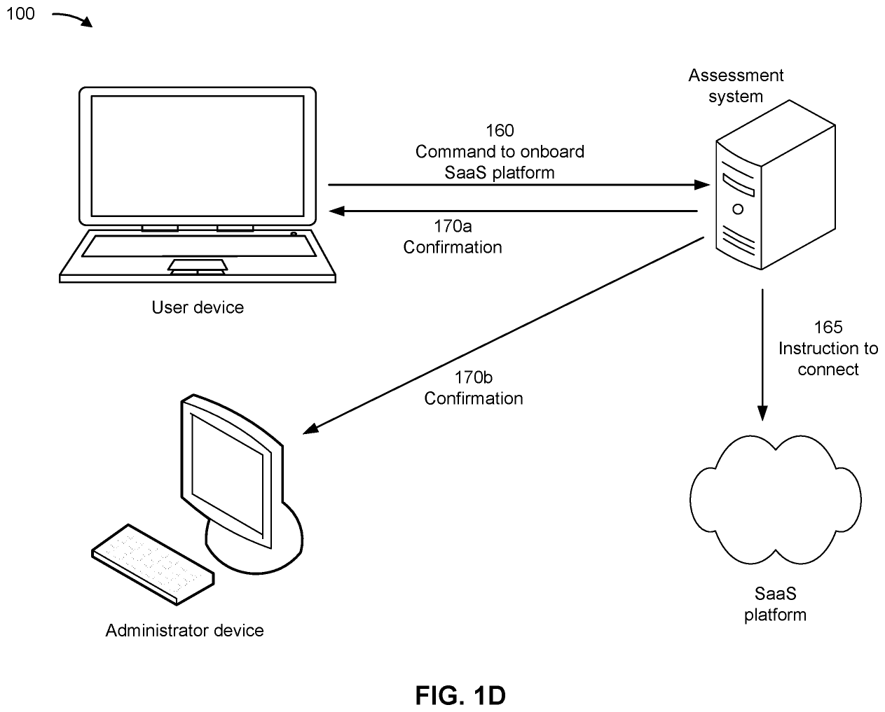

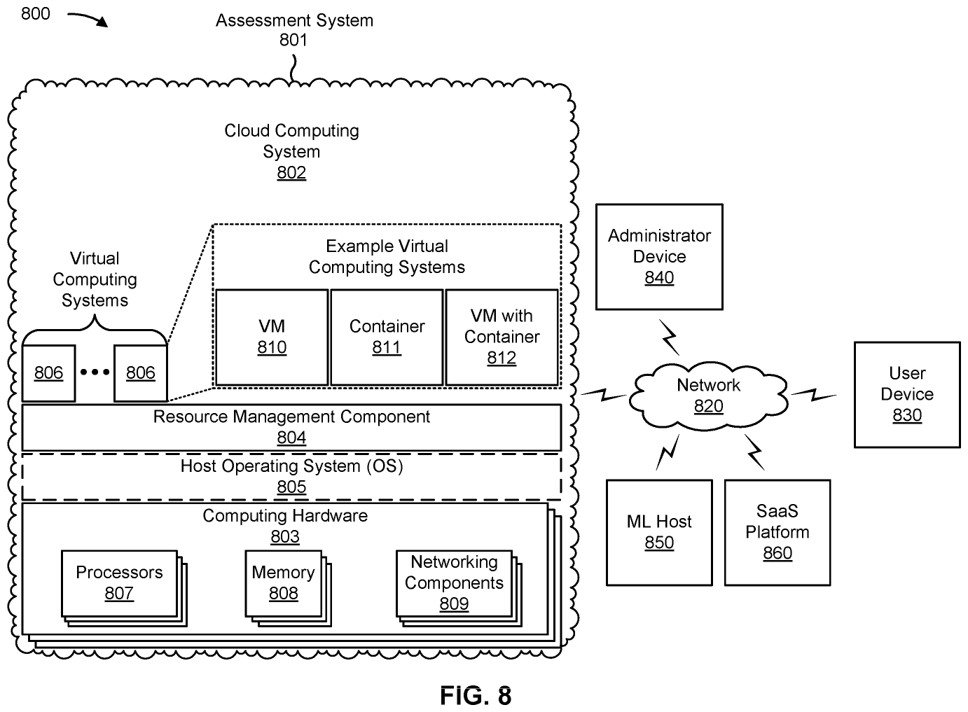

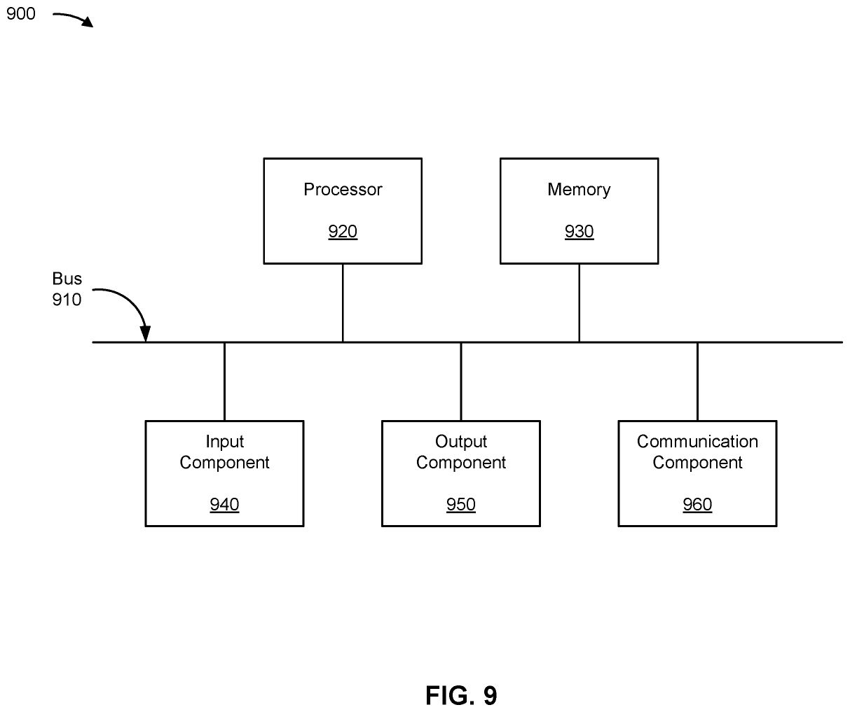

FIGS. 1A-1D are diagrams of an example 100 associated with automated assessment of SaaS platforms. As shown in FIGS. 1A-1D, example 100 includes a user device, an assessment system, an administrator device, an assessment model and a machine learning (ML) model (e.g., provided by an ML host), and a SaaS platform. These devices are described in more detail in connection with FIGS. 8 and 9.

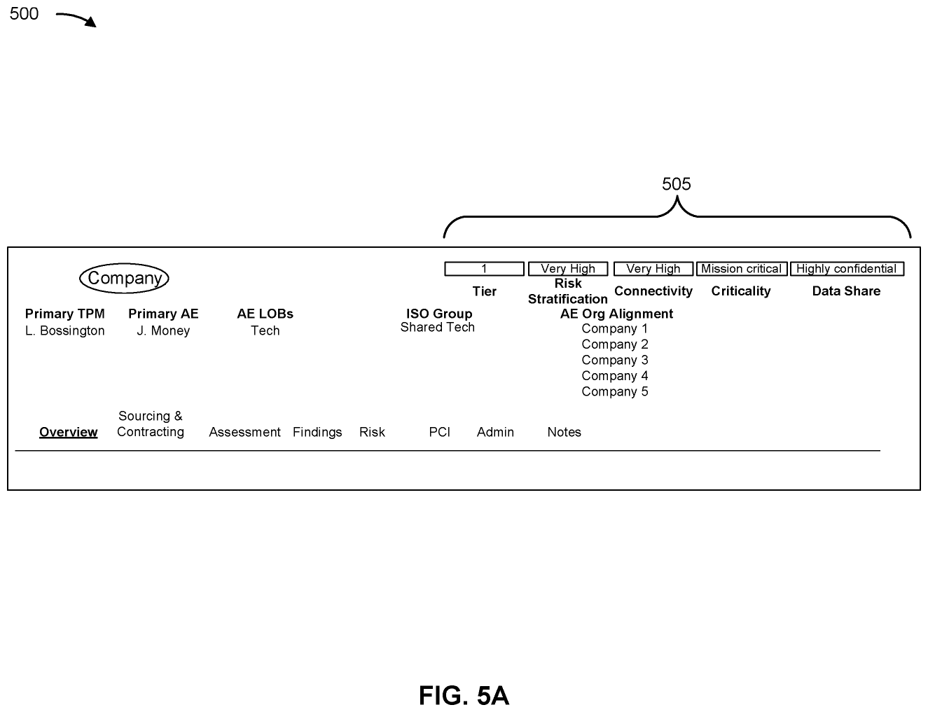

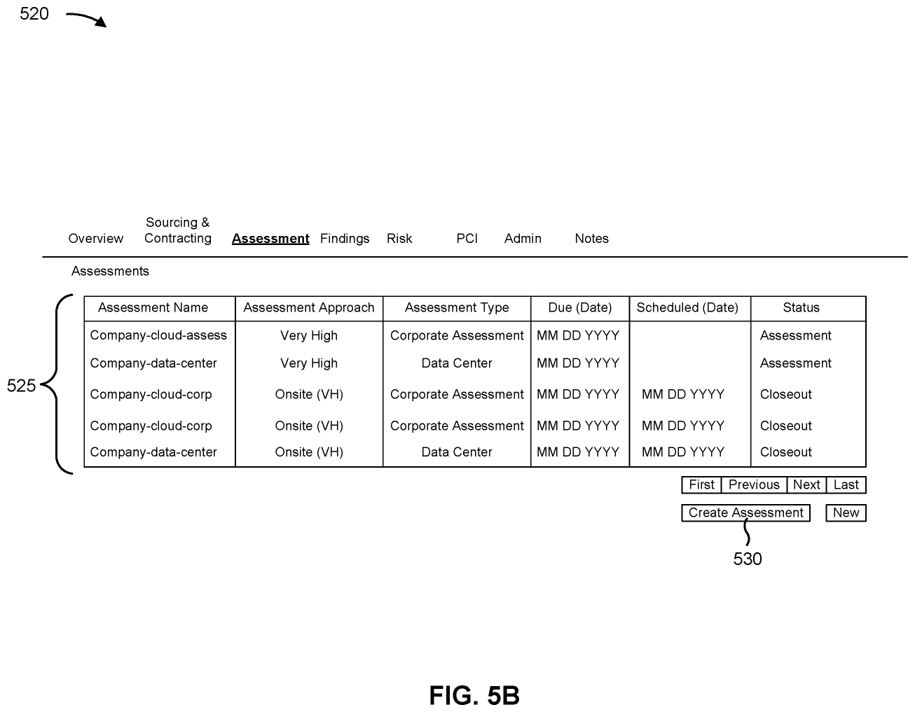

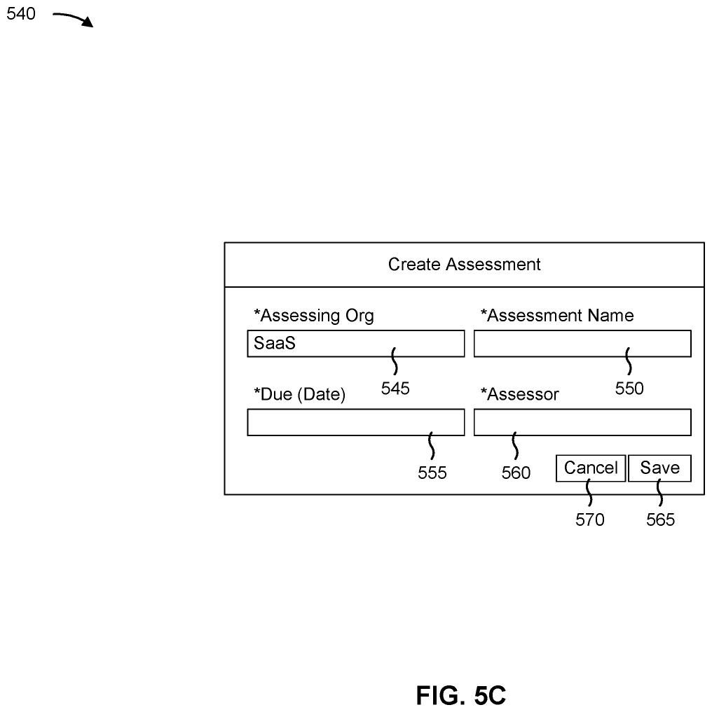

As shown in FIG. 1A and by reference number 105, the user device may transmit, and the assessment system may receive, a request to onboard the SaaS platform. The request may include a hypertext transfer protocol (HTTP) message and/or a call to an API function, among other examples. In some implementations, a user of the user device may provide input (e.g., using an input component of the user device) that triggers the user device to transmit the request. For example, a browser (or another type of application) executed by the user device may navigate to a website controlled by (or at least associated with) the assessment system, and the user device may output a UI (e.g., using an output component of the user device) associated with the website. An example set of UIs for requesting to onboard a SaaS platform is described in connection with FIGS. 5A-5C. Therefore, the user may interact with the UI to provide the input that triggers the user device to transmit the request. In another example, the user may provide the input using a command line or another type of text-based interface.

As shown by reference number 110, the assessment system may provide information associated with the SaaS platform to the ML model. For example, the assessment system may transmit, and the ML host may receive, a request including the information. The information may include an identifier associated with the SaaS platform (e.g., a name and/or another type of alphanumeric identifier) and/or historical information associated with the SaaS platform (e.g., answers previously submitted by a provider of the SaaS platform). The ML model may be trained (e.g., by the ML host and/or a device at least partially separate from the ML host) using a labeled set of data structures representing SaaS platforms (e.g., for supervised learning). The ML model may be configured to determine a suggested answer (e.g., at least one suggested answer) for the SaaS platform (e.g., based on historical information associated with the SaaS platform). For example, the ML model may be trained using historical information and/or service level agreements (SLAs) associated with the SaaS platform. Additionally, or alternatively, the ML model may be trained using an unlabeled set of data structures representing SaaS platforms (e.g., for deep learning). The ML model may be configured to cluster the SaaS platform with other, related SaaS platforms in order to generate a suggested answer (e.g., based on answers associated with SaaS platforms in a same cluster).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the assessment system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 115, the assessment system may receive a form, with the set of questions and populated with the suggested answer, from the ML model (e.g., from the ML host). For example, the ML model may output pre-populated answers for a portion of a set of responses to the set of questions. Therefore, the assessment system may generate the form (with the set of questions associated with the SaaS platform) using the ML model.

By using the ML model to generate the suggested answer, the assessment system conserves network overhead that otherwise would have been increased by communications between the user device and the administrator device. Additionally, the assessment system reduces latency in completing the form and conserves power and processing resources at the administrator device that would have been consumed in completing the form without the suggested answer.

As shown by reference number 120, the assessment system may transmit, and the administrator device may receive, a link to the form. The form includes the set of questions associated with the SaaS platform, and a portion of the form may be populated with the suggested answer. The assessment system may transmit, and the administrator device may receive, a message (e.g., a chat message, an email message, a text message, and/or another type of message) including the link. The link may include a hypertext link (e.g., an HTTP link) or another type of string that the administrator device can use to access the form. Accordingly, the form may be hosted remotely from the administrator device (e.g., at the assessment system or at a third-party system).

The administrator device may be associated with the SaaS platform. For example, the assessment system may use a data structure, that associates identifiers of SaaS platforms (e.g., names and/or other alphanumeric identifiers, among other examples) with identifiers of administrator devices (e.g., Internet protocol (IP) addresses, medium access control (MAC) addresses, and/or device names, among other examples), in order to determine the administrator device to which to transmit the link. The assessment system may maintain the data structure based on input from users. For example, users may indicate which administrator devices are associated with SaaS platforms, and the assessment system may update the data structure accordingly.

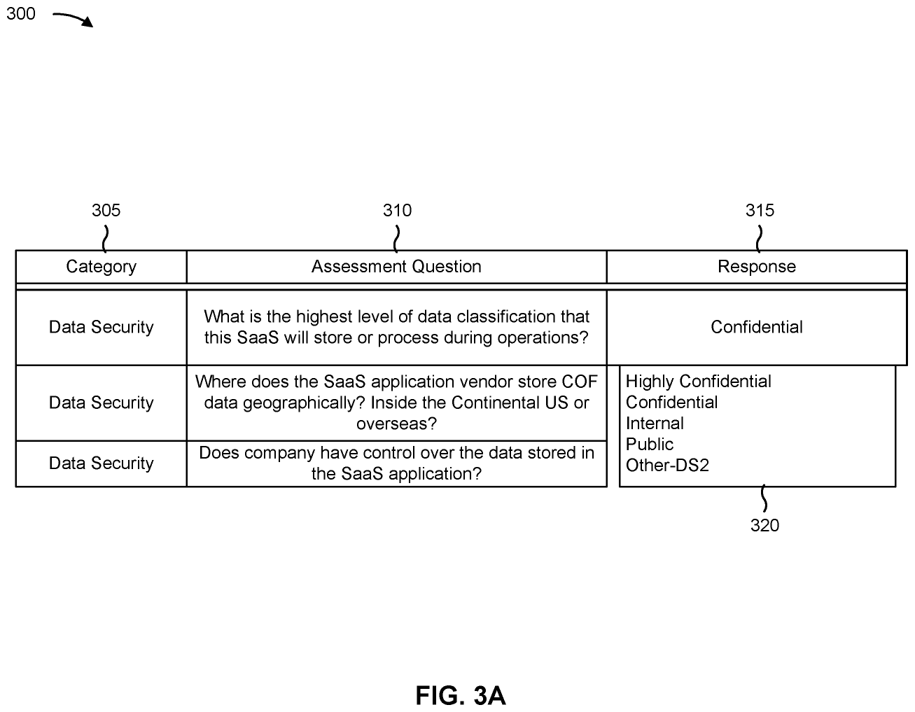

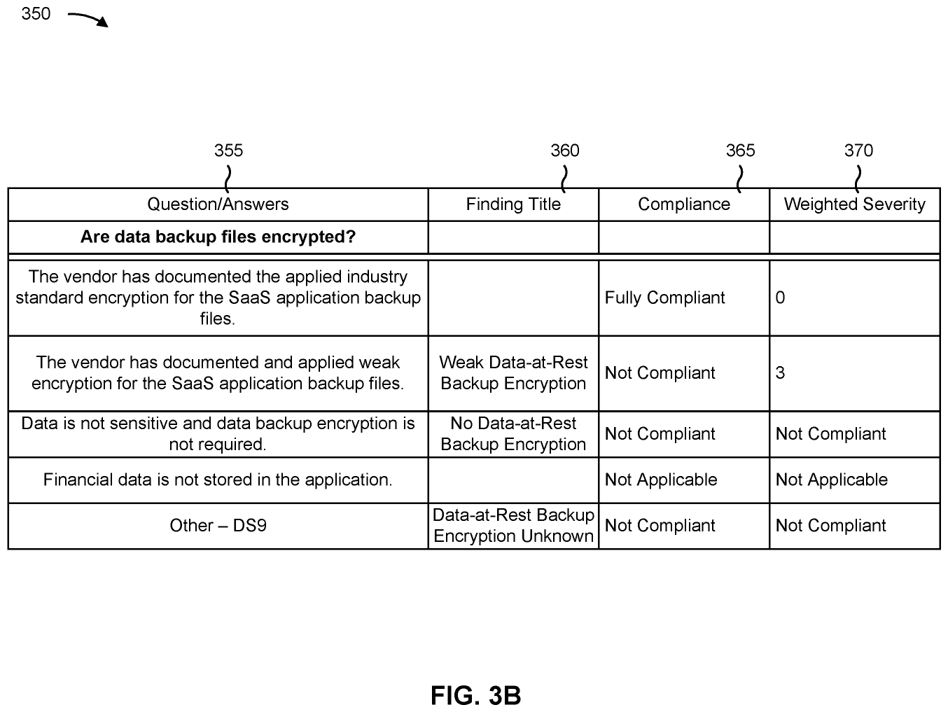

As shown in FIG. 1B and by reference number 125, the form may be dynamic. A subsequent question (e.g., at least one subsequent question), in the set of questions of the form, may be dynamically modified based on an answer (e.g., at least one answer) to a preceding question (e.g., at least one preceding question) in the set of questions. In some implementations, the form may include executable code that dynamically modifies the subsequent question. For example, the form may remove a subsequent question that is rendered irrelevant by the answer to a preceding question. In another example, the form may populate a subsequent question with an answer that is necessitated by the answer to a preceding question. An example of the form is described in connection with FIG. 3A.

Because the form is dynamic, network overhead is reduced because a set of responses collected with the form will be smaller (e.g., because the dynamic form removes irrelevant questions). Additionally, latency in completing the form is reduced because the dynamic form removes irrelevant questions, which conserves power and processing resources at the administrator device that would have been consumed in completing the irrelevant questions.

As shown by reference number 130, the administrator device may transmit, and the assessment system may receive, a set of responses to the set of questions. As described above, a portion of the set of responses may be pre-populated. For example, an administrator using the administrator device may review (and optionally modify) the suggested answer included in the form before submitting the form. Additionally, the administrator may insert answers to a portion of the set of questions that lack suggested answers. In other words, the administrator may complete a portion of the set of responses that are not pre-populated.

In some implementations, the administrator may provide input (e.g., using an input component of the administrator device) that triggers the administrator device to transmit the set of responses. For example, a browser (or another type of application) executed by the administrator device may navigate to the form (e.g., using the link), and the administrator device may output a UI (e.g., using an output component of the administrator device) including the form. Therefore, the administrator may interact with the UI to provide the set of responses and to provide the input that triggers the administrator device to transmit the set of responses.

Although the example 100 shows the administrator device transmitting the set of responses directly to the assessment system, other examples may include the administrator device transmitting the set of responses to a third-party system (e.g., a third-party system hosting the form), and the third-party system may transmit the set of responses to the assessment system. The third-party system may forward the set of responses directly. Alternatively, the third-party system may decode a message (or a plurality of messages) from the administrator system that includes the set of responses and encode a new message (or a plurality of new messages) to transmit to the assessment system that includes the set of responses.

As shown by reference number 135, the assessment system may transmit, and the user device may receive, (a copy of) the set of responses (to the set of questions associated with the SaaS platform). The user device may output the set of responses (e.g., using an output component of the user device) to the user in a UI.

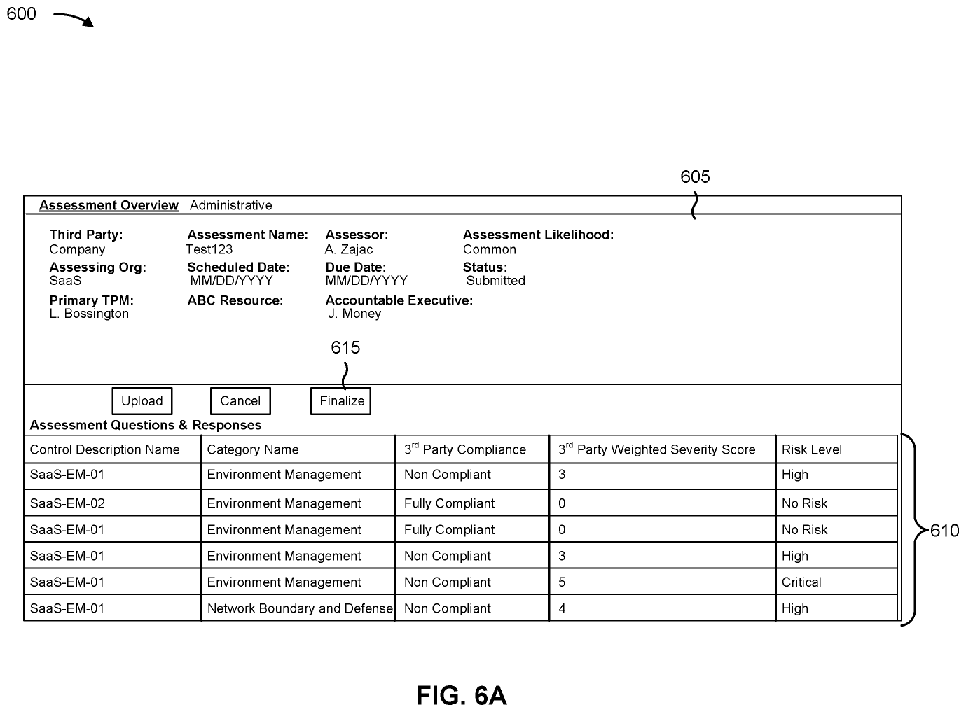

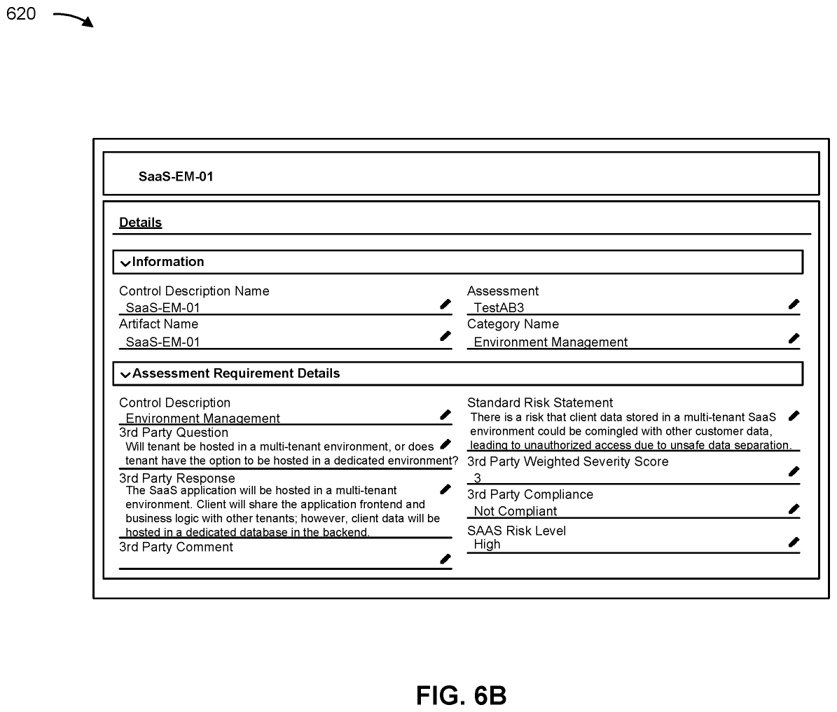

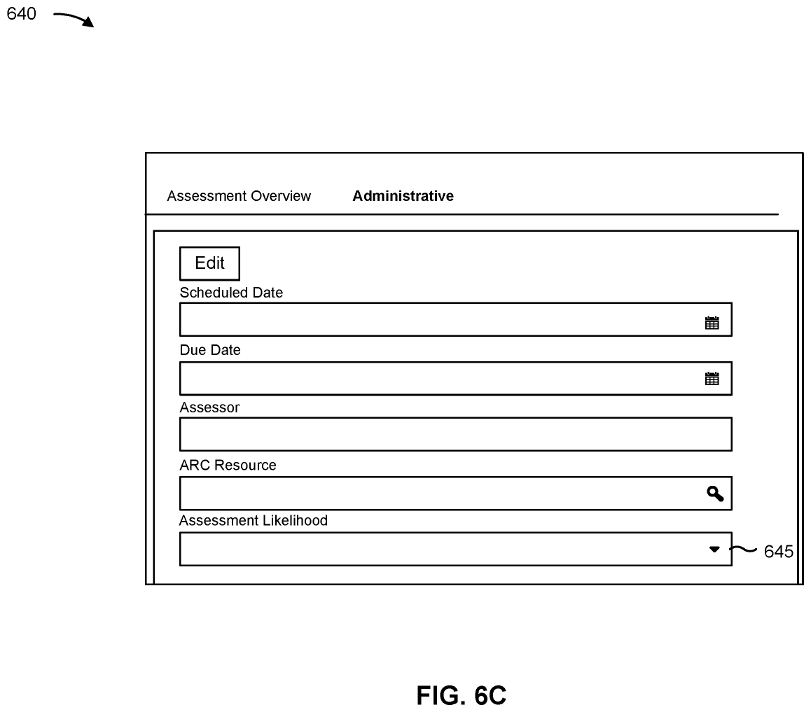

As shown by reference number 140, the user device may transmit, and the assessment system may receive, a command to modify the set of responses. The command may include an HTTP message and/or a call to an API function, among other examples. In some implementations, the user of the user device may provide input (e.g., using an input component of the user device) that triggers the user device to transmit the command. For example, a browser (or another type of application) executed by the user device may receive a message (e.g., an HTTP message) including (a copy of) the set of responses, and the user device may output a UI (e.g., using an output component of the user device) including the set of responses. An example set of UIs for viewing and modifying the set of responses is described in connection with FIGS. 6A-6C. Therefore, the user may interact with the UI to provide the input that triggers the user device to transmit the command. The assessment system may modify the set of responses according to the command (e.g., such that the assessment system provides the set of responses, including any modifications from the user device, to the assessment model, as described below).

As shown in FIG. 1C and by reference number 145, the assessment system may provide the set of responses to the assessment model. For example, the assessment system may transmit, and the ML host may receive, a request including the set of responses. In some implementations, the assessment model may include a set of rules that map answers (in the set of responses) to risk scores. An example UI including (a portion of) the assessment model is described in connection with FIG. 3B.

Additionally, or alternatively, the assessment model may include an ML model (e.g., similar to the ML model described in connection with FIG. 1A). The assessment model may be trained (e.g., by the ML host and/or a device at least partially separate from the ML host) using a labeled set of answers to the set of questions (e.g., for supervised learning). The ML model may be configured to calculate a set of risk scores for the SaaS platform (e.g., based on the set of responses associated with the SaaS platform). Additionally, or alternatively, the ML model may be trained using an unlabeled set of answers to the set of questions (e.g., for deep learning). The ML model may be configured to cluster the set of responses with related answers in order to determine the set of risk scores (e.g., based on risk scores associated with answers in a same cluster).

As shown by reference number 150, the assessment system may receive a set of risk scores, associated with the SaaS platform, from the assessment model (e.g., from the ML host). For example, the assessment model may output a set of risk scores that are calculated based on the set of responses to the set of questions.

Although the example 100 is described in connection with a same ML host providing the ML model in FIG. 1A and the assessment model in FIG. 1C, other examples may include the assessment model being hosted at least partially separately (e.g., virtually, physically, and/or logically) from the ML model. For example, the assessment system may communicate with one host to receive the suggested answer and with a different host to receive the set of risk scores.

By using the assessment model to generate the set of risk scores, the assessment system reduces latency as compared with assessing the set of responses without the set of risk scores as guidance. Additionally, the assessment system conserves power and processing resources at the administrator device that would have been consumed because assessing the set of responses would take significantly longer without the set of risk scores as guidance.

Although the example 100 is described in connection with the user device modifying the set of responses, other examples may additionally or alternatively include the user device modifying the set of risk scores. For example, the user device may transmit, and the assessment system may receive, a command to modify the set of risk scores. The command may include an HTTP message and/or a call to an API function, among other examples. In some implementations, the user of the user device may provide input (e.g., using an input component of the user device) that triggers the user device to transmit the command. For example, a browser (or another type of application) executed by the user device may receive a message (e.g., an HTTP message) including the set of risk scores, and the user device may output a UI (e.g., using an output component of the user device) including the set of risk scores. An example set of UIs for modifying the set of risk scores is described in connection with FIGS. 6A-6C. Therefore, the user may interact with the UI to provide the input that triggers the user device to transmit the command.

The assessment system may modify the set of risk scores according to the command (e.g., such that the assessment system generates a report with the set of risk scores and including any modifications from the user device, as described below). The example 100 is described with any modifications to the set of responses being accepted before the set of risk scores are generated; however, other examples may include the user device providing any modifications to the set of responses in combination with any modifications to the set of risk scores. Therefore, the assessment system may generate the report based on both types of modifications.

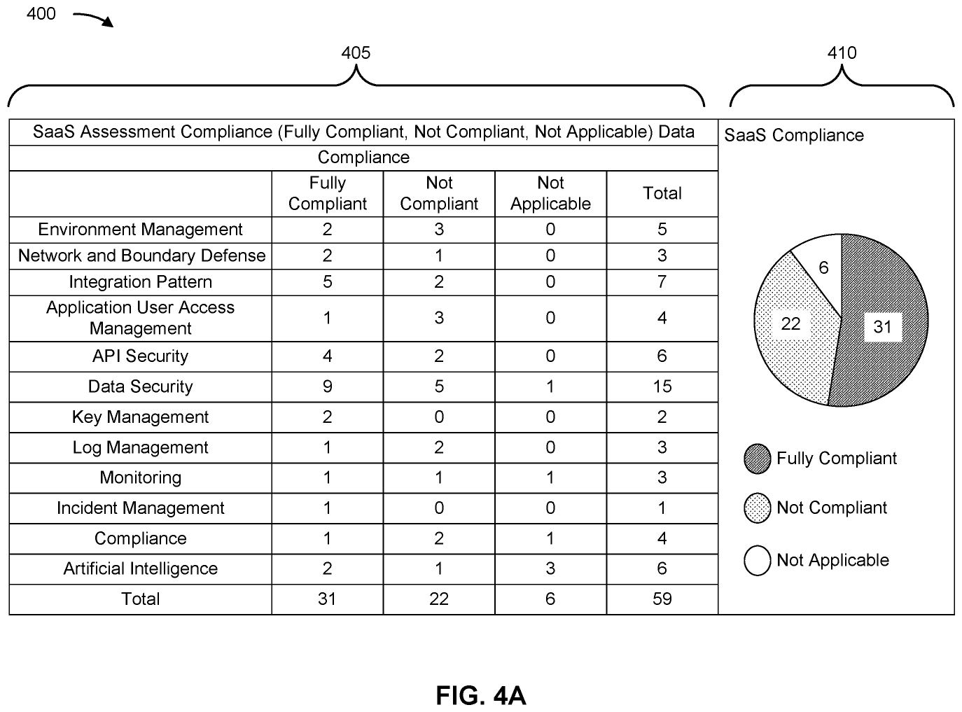

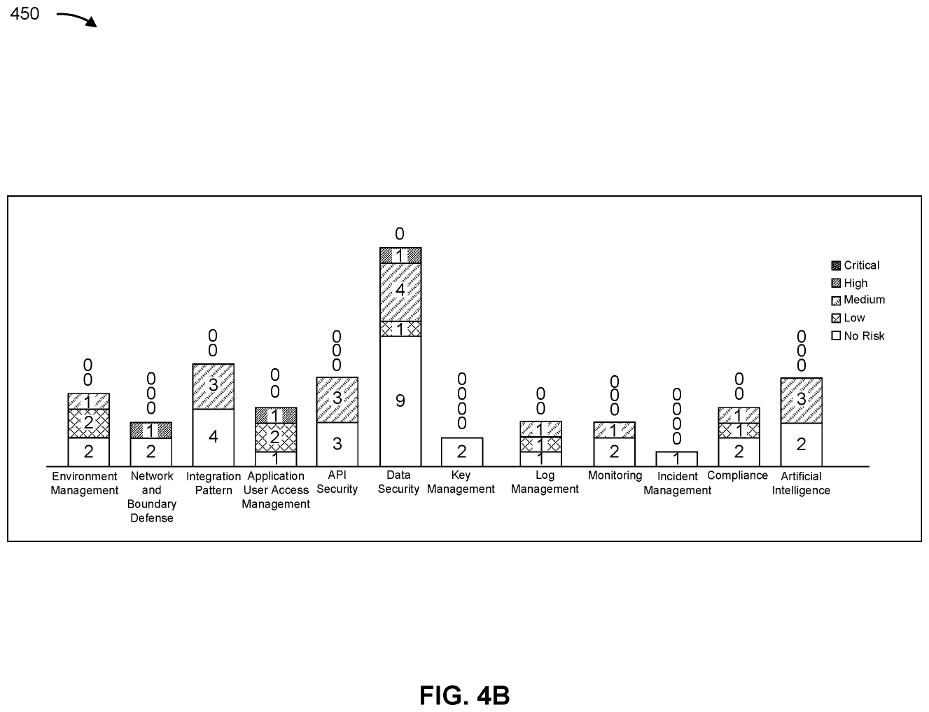

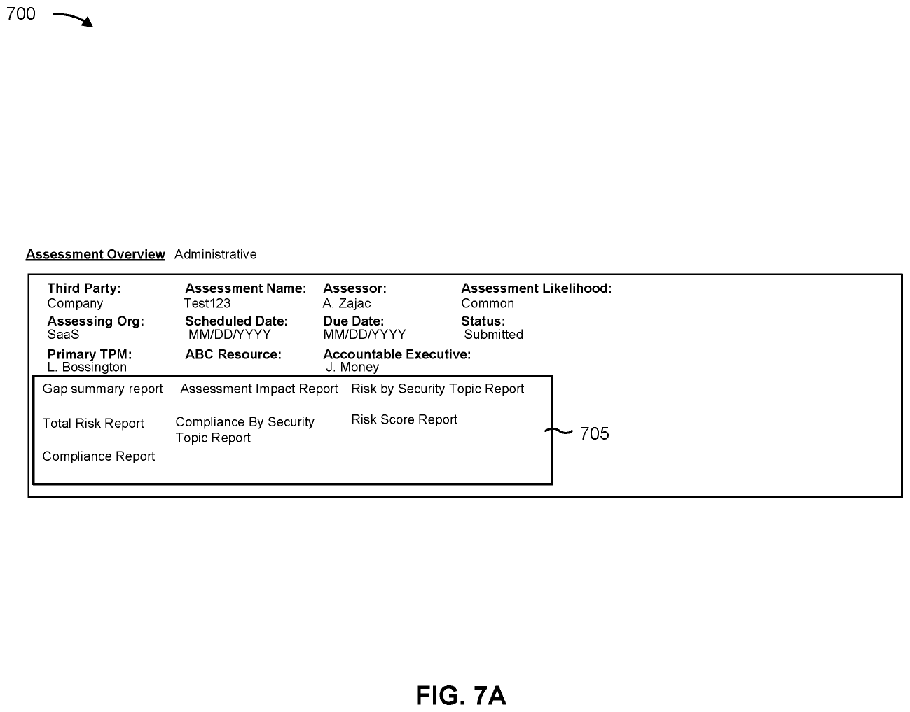

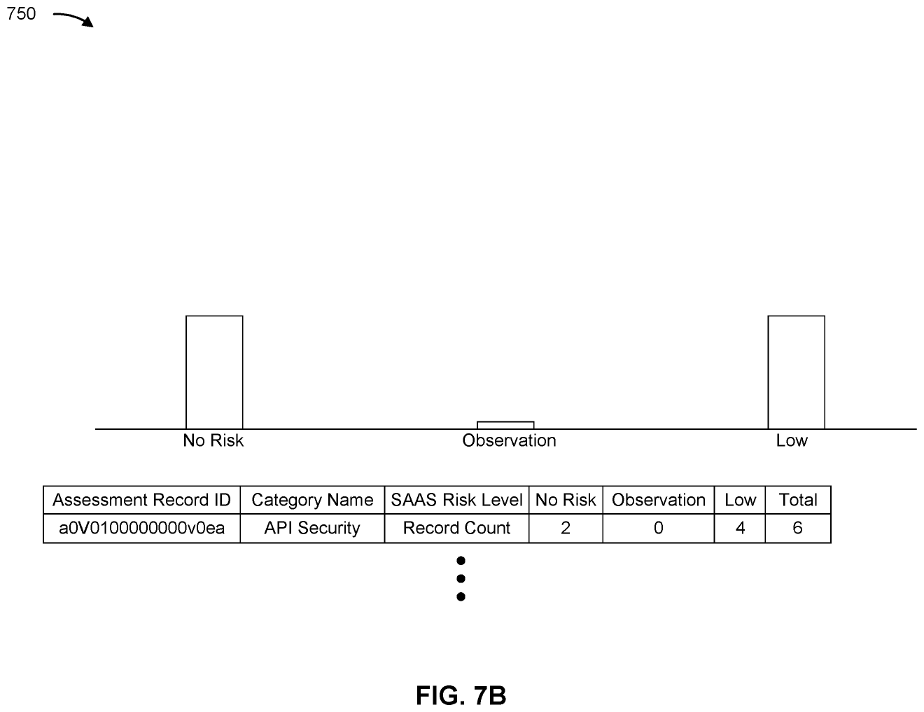

As shown by reference number 155, the assessment system may transmit, and the user device may receive, a report including the set of risk scores. As described above, the set of risk scores may be calculated from the set of responses. The user device may output the report (e.g., using an output component of the user device) to the user in a UI or in a series of UIs. An example report is described in connection with FIGS. 4A-4B. An additional example report is described in connection with FIGS. 7A-7B.

As shown in FIG. 1D and by reference number 160, the user device may transmit, and the assessment system may receive, a command to onboard the SaaS platform. The command may be based on the set of risk scores. For example, the user may review the set of risk scores and provide input that triggers the user device to transmit an instruction to onboard the SaaS platform. Additionally, or alternatively, the user device may automatically transmit an instruction to onboard the SaaS platform (e.g., based on the set of risk scores satisfying one or more risk thresholds).

In response to the command (and/or instruction) from the user device, the assessment system may transmit an instruction (and/or a command) to connect an application (e.g., at least one application) to the SaaS platform, as shown by reference number 165. For example the application may connect to an API (e.g., at least one API) provided by the SaaS platform. As a result, the application may transmit data to the API (e.g., via an endpoint of the API) and/or receive processed data from the API (e.g., as a return from a call to the API).

In some implementations, as shown by reference number 170a, the assessment system may transmit, and the user device may receive, a confirmation that the SaaS platform was (or is being) onboarded. For example, the confirmation may indicate that the application was connected to the SaaS platform (e.g., to the API provided by the SaaS platform). The user device may output the confirmation (e.g., using an output component of the user device) to the user.

Additionally, or alternatively, as shown by reference number 170b, the assessment system may transmit, and the administrator device may receive, a confirmation that the SaaS platform was (or is being) onboarded. For example, the confirmation may indicate that the application was connected to the SaaS platform (e.g., to the API provided by the SaaS platform). The administrator device may output the confirmation (e.g., using an output component of the administrator device) to the administrator.

By using techniques as described in connection with FIGS. 1A-1D, the assessment system automatically transmits (the link to) the form to the administrator device in response to the request to onboard the SaaS platform. Subsequent questions may be dynamically modified based on answers to preceding questions, and the assessment system may populate a portion of the form with suggested answers (e.g., using the ML model). As a result, network overhead is reduced because the dynamic and pre-populated form reduces an amount of communications between the user device and the administrator device. Furthermore, the assessment system uses the assessment model to automatically calculate the set of risk scores based on the set of responses from the administrator device.

As indicated above, FIGS. 1A-1D are provided as an example. Other examples may differ from what is described with regard to FIGS. 1A-1D.

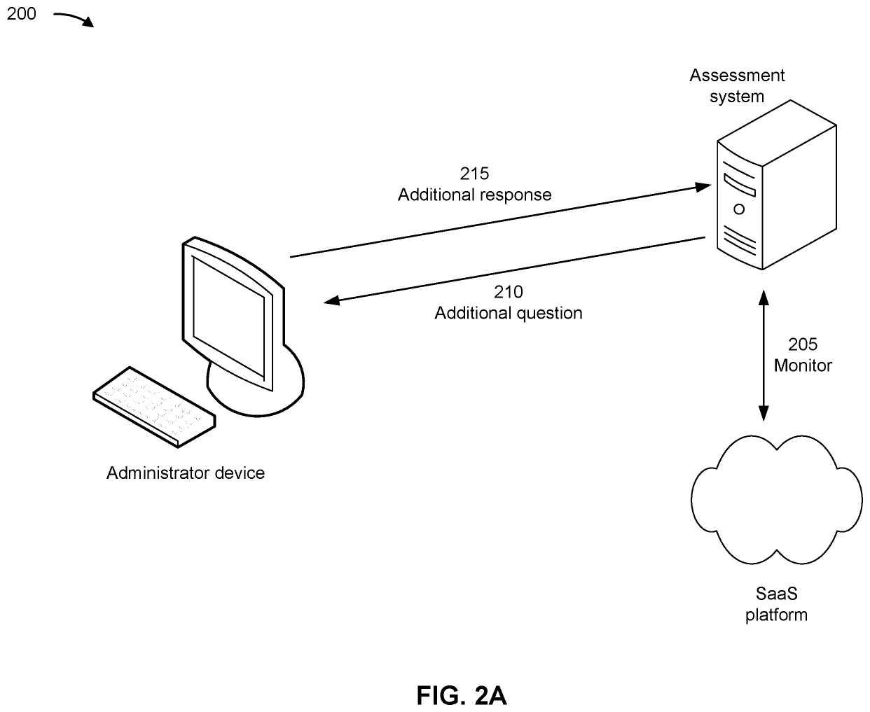

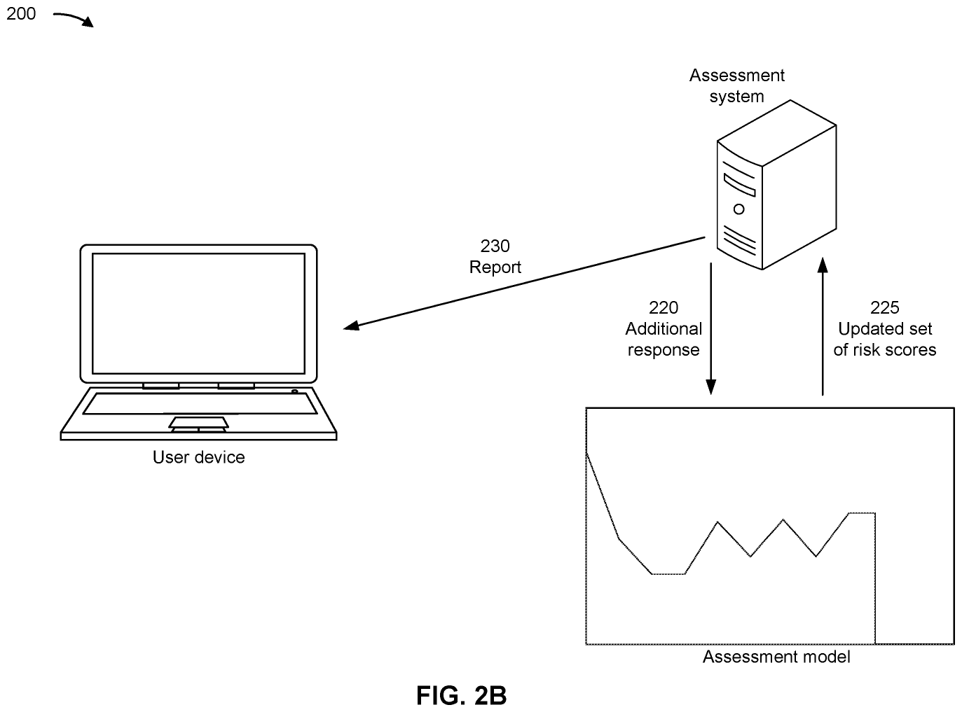

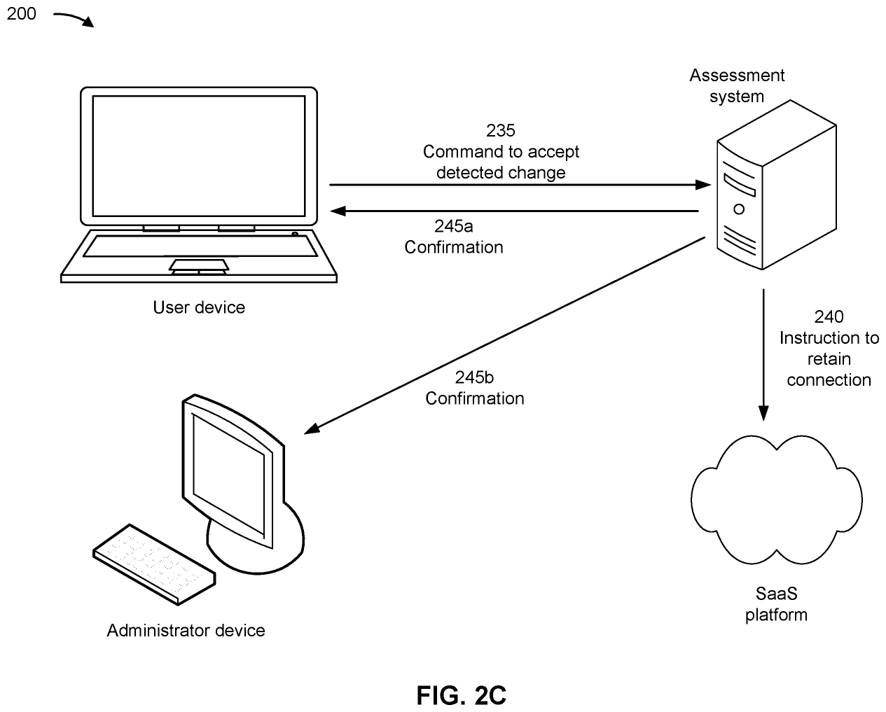

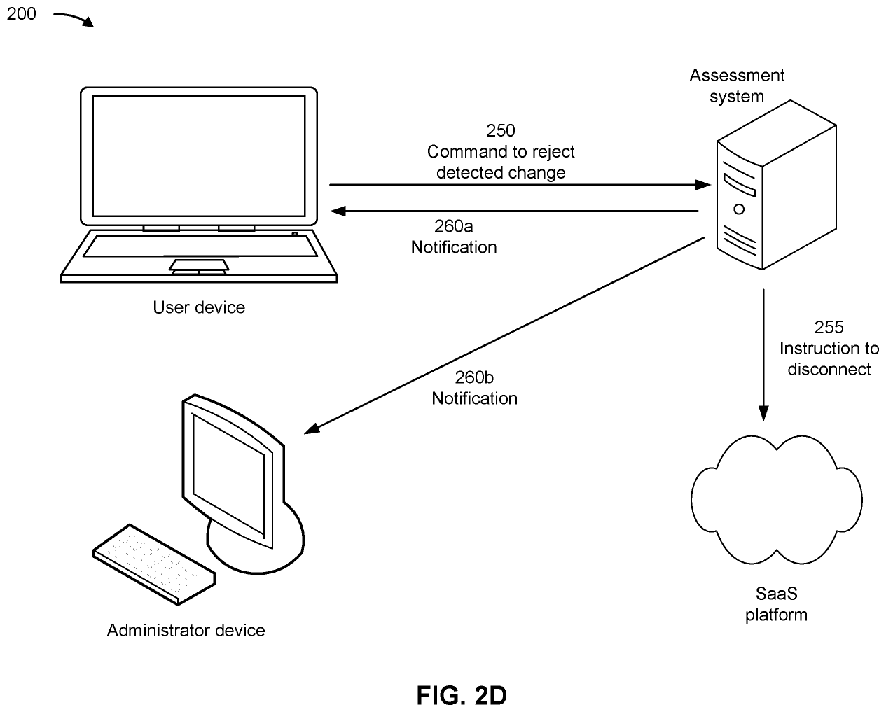

FIGS. 2A-2D are diagrams of an example 200 associated with automatically updating assessments of SaaS platforms. As shown in FIGS. 2A-2D, example 200 includes a user device, an assessment system, an administrator device, an assessment model (e.g., provided by an ML host), and a SaaS platform. These devices are described in more detail in connection with FIGS. 8 and 9.

As shown in FIG. 2A and by reference number 205, the assessment system may monitor a configuration associated with the SaaS platform for a detected change. For example, the assessment system may track a configuration file (e.g., at least one configuration file), associated with the SaaS platform, for modifications. In other words, the detected change may be triggered by a modification to the configuration file. Additionally, or alternatively, the assessment system may monitor traffic, associated with an API (e.g., at least one API) of the SaaS platform, to detect traffic pattern changes. Traffic pattern changes may include a change in average packet size, a change in average quantity of packets in a time window (e.g., a slow-moving average or another type of time-smoothed measurement), and/or a change in latency, among other examples. Therefore, the detected change may be triggered by a traffic pattern change that satisfies a change threshold. Additionally, or alternatively, the assessment system may scan data, received from the SaaS platform, for format changes. In other words, the detected change may be triggered by reception of data from the SaaS platform that is encoded in a new format.

Although the example 200 is described in connection with the assessment system directly monitoring the SaaS platform, other examples may include the assessment system receiving indications of changes to the SaaS platform from a third-party monitoring system. Accordingly, monitoring the configuration associated with the SaaS platform may include receiving an indication of the detected change from the third-party monitoring system.

As shown by reference number 210, the assessment system may transmit, and the administrator device may receive, an additional question in response to the detected change. For example, the assessment system may add a new question to a form (e.g., as described in connection with FIGS. 1A-1B) in response to the detected change and may transmit a link to the form (e.g., as described in connection with reference number 120 of FIG. 1A) with the new question. In another example, the assessment system may clear a previous response from the form (in response to the detected change) and may transmit a link to the form (e.g., as described in connection with reference number 120 of FIG. 1A) with a blank in place of the previous response.

As shown by reference number 215, the administrator device may transmit, and the assessment system may receive, an additional response to the additional question. As described above, the additional response may be for a new question or in place of a previous question. In some implementations, a portion of the additional response may be pre-populated. For example, the assessment system may use an ML model to generate a suggested answer for the additional question (e.g., as described in connection with FIG. 1A). Accordingly, an administrator using the administrator device may review (and optionally modify) the suggested answer before submitting the additional response.

In some implementations, the administrator may provide input (e.g., using an input component of the administrator device) that triggers the administrator device to transmit the additional response. For example, a browser (or another type of application) executed by the administrator device may navigate to the form (e.g., using the link), and the administrator device may output a UI (e.g., using an output component of the administrator device) including the form. Therefore, the administrator may interact with the UI to provide the additional response and to provide the input that triggers the administrator device to transmit the additional response.

Although the example 200 shows the administrator device transmitting additional response directly to the assessment system, other examples may include the administrator device transmitting the additional response to a third-party system (e.g., a third-party system hosting the form), and the third-party system may transmit the additional response to the assessment system. The third-party system may forward the additional response directly. Alternatively, the third-party system may decode a message (or a plurality of messages) from the administrator system that includes the additional response and encode a new message (or a plurality of new messages) to transmit to the assessment system that includes the additional response.

As shown in FIG. 2B and by reference number 220, the assessment system may provide the additional response to the assessment model. For example, the assessment system may transmit, and the ML host may receive, a request including the additional response. In some implementations, the assessment model may include a set of rules that map answers (e.g., the additional response) to risk scores. An example UI including (a portion of) the assessment model is described in connection with FIG. 3B.

Additionally, or alternatively, the assessment model may include an ML model (e.g., similar to the ML model described in connection with FIG. 1A). The assessment model may be trained (e.g., by the ML host and/or a device at least partially separate from the ML host) using a labeled set of answers (e.g., for supervised learning). The ML model may be configured to calculate a set of risk scores for the SaaS platform (e.g., based on the set of responses associated with the SaaS platform). Additionally, or alternatively, the ML model may be trained using an unlabeled set of answers (e.g., for deep learning). The ML model may be configured to cluster the set of responses with related answers in order to determine the set of risk scores (e.g., based on risk scores associated with answers in a same cluster).

As shown by reference number 225, the assessment system may receive an updated set of risk scores, associated with the SaaS platform, from the assessment model (e.g., from the ML host). For example, the assessment model may output an update, to a set of risk scores, that is calculated based on the additional response to the additional question.

As shown by reference number 230, the assessment system may transmit, and the user device may receive, a report including the updated set of risk scores. As described above, the updated set of risk scores may be calculated, at least in part, from the additional response. The user device may output the report (e.g., using an output component of the user device) to the user in a UI or in a series of UIs. An example report is described in connection with FIGS. 4A-4B. An additional example report is described in connection with FIGS. 7A-7B.

Although not shown in the example 200, other examples may include the user device modifying the additional response and/or modifying the set of risk scores. For example, the user device may transmit, and the assessment system may receive, a command to modify the additional response and/or modify the updated set of risk scores. The command may include an HTTP message and/or a call to an API function, among other examples. In some implementations, the user of the user device may provide input (e.g., using an input component of the user device) that triggers the user device to transmit the command. For example, a browser (or another type of application) executed by the user device may receive a message (e.g., an HTTP message) including the additional response and/or the updated set of risk scores, and the user device may output a UI (e.g., using an output component of the user device) including the additional response and/or the updated set of risk scores. Therefore, the user may interact with the UI to provide the input that triggers the user device to transmit the command.

The assessment system may modify the updated set of risk scores according to the command (e.g., such that the assessment system generates a report with the updated set of risk scores and including any modifications from the user device, as described below). The assessment system may additionally or alternatively accept any modifications to the additional response before the updated set of risk scores are generated or after the updated set of risk scores are generated. The assessment system may, in either implementation, generate the report based on both types of modifications.

As shown in FIG. 2C, the user device may accept the detected change. For example, as shown by reference number 235, the user device may transmit, and the assessment system may receive, a command to allow the detected change. The command may be based on the updated set of risk scores. For example, the user may review the updated set of risk scores and provide input that triggers the user device to transmit an instruction to (continue to) authorize the SaaS platform. Additionally, or alternatively, the user device may automatically transmit an instruction to (continue to) authorize the SaaS platform (e.g., based on the updated set of risk scores satisfying one or more risk thresholds).

In response to the command (and/or instruction) from the user device, the assessment system may transmit an instruction (and/or a command) to retain a connection between an application (e.g., at least one application) and the SaaS platform, as shown by reference number 240. For example the application may be connected to an API (e.g., at least one API) provided by the SaaS platform. As a result, the application may continue to transmit data to the API (e.g., via an endpoint of the API) and/or continue to receive processed data from the API (e.g., as a return from a call to the API).

In some implementations, as shown by reference number 245a, the assessment system may transmit, and the user device may receive, a confirmation that the detected change was accepted. For example, the confirmation may indicate that the application remains connected to the SaaS platform (e.g., to the API provided by the SaaS platform). The user device may output the confirmation (e.g., using an output component of the user device) to the user.

Additionally, or alternatively, as shown by reference number 245b, the assessment system may transmit, and the administrator device may receive, a confirmation that the detected change was accepted. For example, the confirmation may indicate that the application remains connected to the SaaS platform (e.g., to the API provided by the SaaS platform). The administrator device may output the confirmation (e.g., using an output component of the administrator device) to the administrator.

Alternatively, as shown in FIG. 2D, the user device may reject the detected change. For example, as shown by reference number 250, the user device may transmit, and the assessment system may receive, a command to reject the detected change. The command may be based on the updated set of risk scores. For example, the user may review the updated set of risk scores and provide input that triggers the user device to transmit an instruction to disable the SaaS platform. Additionally, or alternatively, the user device may automatically transmit an instruction to disable the SaaS platform (e.g., based on the updated set of risk scores failing to satisfy one or more risk thresholds).

In response to the command (and/or instruction) from the user device, the assessment system may transmit an instruction (and/or a command) to disconnect an application (e.g., at least one application) from the SaaS platform, as shown by reference number 255. For example the application may disconnect from an API (e.g., at least one API) provided by the SaaS platform. As a result, the application may cease transmitting data to the API (e.g., via an endpoint of the API) and/or cease receiving processed data from the API (e.g., as a return from a call to the API).

In some implementations, as shown by reference number 260a, the assessment system may transmit, and the user device may receive, a confirmation that the detected change was rejected. For example, the confirmation may indicate that the application was disconnected from the SaaS platform (e.g., from the API provided by the SaaS platform). The user device may output the confirmation (e.g., using an output component of the user device) to the user.

Additionally, or alternatively, as shown by reference number 260b, the assessment system may transmit, and the administrator device may receive, a confirmation that the detected change was rejected. For example, the confirmation may indicate that the application was disconnected from the SaaS platform (e.g., from the API provided by the SaaS platform). The administrator device may output the confirmation (e.g., using an output component of the administrator device) to the administrator.

By using techniques as described in connection with FIGS. 2A-2D, the assessment system may monitor the SaaS platform for a detected change and may automatically transmit the additional question to the administrator device based on the detected change. As a result, network overhead is reduced because the detected change automatically triggers updated assessment of the SaaS platform, which reduces communications between the user device and the administrator device.

As indicated above, FIGS. 2A-2D are provided as an example. Other examples may differ from what is described with regard to FIGS. 2A-2D.

FIGS. 3A and 3B are diagrams of example UIs 300 and 350, respectively, associated with an automated assessment of a SaaS platform. The example UI 300 may be output by an administrator device (e.g., based on instructions from an assessment system), and the example UI 350 may be shown by a user device (e.g., based on instructions from the assessment system). These devices are described in more detail in connection with FIGS. 8 and 9.

As shown in FIG. 3A, the example UI 300 may include a form with a set of questions 310, organized according to categories 305, for an administrator associated with the SaaS platform. Additionally, the form may include a set of fields 315 for a set of responses corresponding to the set of questions. Some questions may be associated with a pre-defined set of responses, which may be included in a drop-down menu 320 (or another type of selector element).

As shown in FIG. 3B, the example UI 350 may indicate a data structure that associates a set of responses 355 with a set of rules for calculating a set of risk scores associated with the SaaS platform. In the example UI 350, the set of rules includes a set of titles 360, a set of compliance indicators 365, and a set of weights 370.

As indicated above, FIGS. 3A-3B are provided as examples. Other examples may differ from what is described with regard to FIGS. 3A-3B. For example, the set of titles 360, the set of compliance indicators 365, and/or the set of weights 370 may be omitted from the set of rules.

FIGS. 4A and 4B are diagrams of example UIs 400 and 450, respectively, associated with a report including an assessment of a SaaS platform. The example UIs 400 and/or 450 may be output by a user device (e.g., based on instructions from an assessment system). These devices are described in more detail in connection with FIGS. 8 and 9.

As shown in FIG. 4A, the example UI 400 may indicate a set of risk scores 405 associated with the SaaS platform. The set of risk scores 405 may be organized by category, as further shown in FIG. 4A. Additionally, the example UI 400 may include a graph 410 illustrating the set of risk scores. For example, the graph 410 may include a pie chart, as shown in FIG. 4A.

As shown in FIG. 4B, the example UI 450 may include a bar graph illustrating the set of risk scores. The graph may be organized by category, as further shown in FIG. 4B.

As indicated above, FIGS. 4A-4B are provided as examples. Other examples may differ from what is described with regard to FIGS. 4A-4B. For example, the graph 410 in FIG. 4A may include a bar graph, a line graph, and/or another type of graph, rather than a pie chart. Additionally, or alternatively, the graph in FIG. 4B may include a pie chart, a line graph, and/or another type of graph, rather than a bar graph.

FIGS. 5A, 5B, and 5C are diagrams of example UIs 500, 520, and 540, respectively, associated with initiating assessment of a SaaS platform. The example UIs 500, 520, and/or 540 may be output by a user device (e.g., based on instructions from an assessment system). These devices are described in more detail in connection with FIGS. 8 and 9.

As shown in FIG. 5A, the example UI 500 may include information 505 associated with (a provider of) the SaaS platform. The information 505 may be used, at least in part, to generate pre-populated answers for a form (e.g., as described in connection with FIG. 1A).

As shown in FIG. 5B, the example UI 520 may include a list 525 of previous assessments associated with the provider of the SaaS platform. A user may move between the example UI 500 and the example UI 520 using tabs (e.g., by interacting with “Overview” and “Assessment” tabs, respectively, as shown in FIGS. 5A and 5B). Additionally, the example UI 520 may include an interactive element 530 (e.g., a button) that initializes a request to onboard the SaaS platform.

As shown in FIG. 5C, the example UI 540 may include an input element 545 (e.g., a text box) for indicating an assessing organization (e.g., an organization for which the user is submitting a request to onboard the SaaS platform) and an input element 550 (e.g., a text box) for indicating a name associated with an assessment of the SaaS platform. Additionally, the example UI 540 may include an input element 555 (e.g., a text box) for indicating a due date (e.g., for receiving a set of responses from the provider of the SaaS platform) and an input element 560 (e.g., a text box) for indicating the user (who is requesting to onboard the SaaS platform). The example UI 540 of FIG. 5C may be output in response to interaction with the interactive element 530 of the example UI 520 of FIG. 5B.

As further shown in FIG. 5C, the example UI 540 may include an interactive element 565 (e.g., a button) that triggers the user device to transmit the request to onboard the SaaS platform and an interactive element 570 (e.g., a button) that cancels the request to onboard the SaaS platform.

As indicated above, FIGS. 5A-5C are provided as examples. Other examples may differ from what is described with regard to FIGS. 5A-5C. For example, one or more of the input elements 545, 550, 555, or 560 may be omitted in some implementations.

FIGS. 6A, 6B, and 6C are diagrams of example UIs 600, 620, and 640, respectively, associated with modifying an assessment of a SaaS platform. The example UIs 600, 620, and/or 640 may be output by a user device (e.g., based on instructions from an assessment system). These devices are described in more detail in connection with FIGS. 8 and 9.

As shown in FIG. 6A, the example UI 600 may include information 605 associated with the assessment of the SaaS platform and may indicate a set of risk scores 610 calculated for the SaaS platform (e.g., as described in connection with FIG. 1C). As further shown in FIG. 6A, the example UI 600 may include an interactive element 615 (e.g., a button) that accepts the set of risk scores 610 without modification.

On the other hand, a user may use the example UI 620 of FIG. 6B to modify the set of risk scores 610 (and/or a set of responses upon which the set of risk scores 610 are based). For example, pencil icons shown in FIG. 6B may be used to modify responses (and/or risk scores) adjacent to the pencil icons.

Additionally, or alternatively, a user may use the example UI 640 of FIG. 6C to modify an overall risk score associated with the SaaS platform. The example UI 640 may include a drop-down menu 645 (or another type of selector element) to modify the overall risk score.

As indicated above, FIGS. 6A-6C are provided as examples. Other examples may differ from what is described with regard to FIGS. 6A-6C.

FIGS. 7A and 7B are diagrams of example UIs 700 and 750, respectively, associated with a report including an assessment of a SaaS platform. The example UIs 700 and/or 750 may be output by a user device (e.g., based on instructions from an assessment system). These devices are described in more detail in connection with FIGS. 8 and 9.

As shown in FIG. 7A, the example UI 700 may include a set of links 705 for viewing different portions of the report. The example UI 750 of FIG. 7B may be output in response to interaction with the “Total Risk Report” link in FIG. 7A. The example UI 750 includes a bar graph of risk scores for a SaaS platform (or a set of SaaS platforms) with a table of risk scores by category.

As indicated above, FIGS. 7A-7B are provided as examples. Other examples may differ from what is described with regard to FIGS. 7A-7B. For example, the example UI 750 may include a pie chart, a line graph, and/or another type of graph, rather than a bar graph.

FIG. 8 is a diagram of an example environment 800 in which systems and/or methods described herein may be implemented. As shown in FIG. 8, environment 800 may include an assessment system 801, which may include one or more elements of and/or may execute within a cloud computing system 802. The cloud computing system 802 may include one or more elements 803-812, as described in more detail below. As further shown in FIG. 8, environment 800 may include a network 820, a user device 830, an administrator device 840, an ML host 850, and/or a SaaS platform 860. Devices and/or elements of environment 800 may interconnect via wired connections and/or wireless connections.

The cloud computing system 802 may include computing hardware 803, a resource management component 804, a host operating system (OS) 805, and/or one or more virtual computing systems 806. The cloud computing system 802 may execute on, for example, an Amazon Web Services platform, a Microsoft Azure platform, or a Snowflake platform. The resource management component 804 may perform virtualization (e.g., abstraction) of computing hardware 803 to create the one or more virtual computing systems 806. Using virtualization, the resource management component 804 enables a single computing device (e.g., a computer or a server) to operate like multiple computing devices, such as by creating multiple isolated virtual computing systems 806 from computing hardware 803 of the single computing device. In this way, computing hardware 803 can operate more efficiently, with lower power consumption, higher reliability, higher availability, higher utilization, greater flexibility, and lower cost than using separate computing devices.

The computing hardware 803 may include hardware and corresponding resources from one or more computing devices. For example, computing hardware 803 may include hardware from a single computing device (e.g., a single server) or from multiple computing devices (e.g., multiple servers), such as multiple computing devices in one or more data centers. As shown, computing hardware 803 may include one or more processors 807, one or more memories 808, and/or one or more networking components 809. Examples of a processor, a memory, and a networking component (e.g., a communication component) are described elsewhere herein.

The resource management component 804 may include a virtualization application (e.g., executing on hardware, such as computing hardware 803) capable of virtualizing computing hardware 803 to start, stop, and/or manage one or more virtual computing systems 806. For example, the resource management component 804 may include a hypervisor (e.g., a bare-metal or Type 1 hypervisor, a hosted or Type 2 hypervisor, or another type of hypervisor) or a virtual machine monitor, such as when the virtual computing systems 806 are virtual machines 810. Additionally, or alternatively, the resource management component 804 may include a container manager, such as when the virtual computing systems 806 are containers 811. In some implementations, the resource management component 804 executes within and/or in coordination with a host operating system 805.

A virtual computing system 806 may include a virtual environment that enables cloud-based execution of operations and/or processes described herein using computing hardware 803. As shown, a virtual computing system 806 may include a virtual machine 810, a container 811, or a hybrid environment 812 that includes a virtual machine and a container, among other examples. A virtual computing system 806 may execute one or more applications using a file system that includes binary files, software libraries, and/or other resources required to execute applications on a guest operating system (e.g., within the virtual computing system 806) or the host operating system 805.

Although the assessment system 801 may include one or more elements 803-812 of the cloud computing system 802, may execute within the cloud computing system 802, and/or may be hosted within the cloud computing system 802, in some implementations, the assessment system 801 may not be cloud-based (e.g., may be implemented outside of a cloud computing system) or may be partially cloud-based. For example, the assessment system 801 may include one or more devices that are not part of the cloud computing system 802, such as device 900 of FIG. 9, which may include a standalone server or another type of computing device. The assessment system 801 may perform one or more operations and/or processes described in more detail elsewhere herein.

The network 820 may include one or more wired and/or wireless networks. For example, the network 820 may include a cellular network, a public land mobile network (PLMN), a local area network (LAN), a wide area network (WAN), a private network, the Internet, and/or a combination of these or other types of networks. The network 820 enables communication among the devices of the environment 800.

The user device 830 may include one or more devices capable of receiving, generating, storing, processing, and/or providing reports and/or other information associated with SaaS platforms, as described elsewhere herein. The user device 830 may include a communication device and/or a computing device. For example, the user device 830 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 830 may communicate with one or more other devices of environment 800, as described elsewhere herein.

The administrator device 840 may include one or more devices capable of receiving, generating, storing, processing, and/or providing information associated with responses to questions about SaaS platforms, as described elsewhere herein. The administrator device 840 may include a communication device and/or a computing device. For example, the administrator device 840 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 840 may communicate with one or more other devices of environment 800, as described elsewhere herein.

The ML host 850 may include one or more devices capable of receiving, generating, storing, processing, and/or providing information associated with assessment and/or machine learning models, as described elsewhere herein. The ML host 850 may include a communication device and/or a computing device. For example, the ML host 850 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 850 may communicate with one or more other devices of environment 800, as described elsewhere herein.

The SaaS platform 860 may include one or more devices capable of providing APIs, as described elsewhere herein. The SaaS platform 860 may include a communication device and/or a computing device. For example, the SaaS platform 860 may include a server, such as an application server, a client server, a web server, a database server, a host server, a proxy server, a virtual server (e.g., executing on computing hardware), or a server in a cloud computing system. In some implementations, the SaaS platform 860 may include computing hardware used in a cloud computing environment. The SaaS platform 860 may communicate with one or more other devices of environment 800, as described elsewhere herein.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of the environment 800 may perform one or more functions described as being performed by another set of devices of the environment 800.

FIG. 9 is a diagram of example components of a device 900 associated with automated assessment of SaaS platforms. The device 900 may correspond to a user device 830, an administrator device 840, an ML host 850, and/or a SaaS platform 860. In some implementations, a user device 830, an administrator device 840, an ML host 850, and/or a SaaS platform 860 may include one or more devices 900 and/or one or more components of the device 900. As shown in FIG. 9, the device 900 may include a bus 910, a processor 920, a memory 930, an input component 940, an output component 950, and/or a communication component 960.

The bus 910 may include one or more components that enable wired and/or wireless communication among the components of the device 900. The bus 910 may couple together two or more components of FIG. 9, such as via operative coupling, communicative coupling, electronic coupling, and/or electric coupling. For example, the bus 910 may include an electrical connection (e.g., a wire, a trace, and/or a lead) and/or a wireless bus. The processor 920 may include a central processing unit, a graphics processing unit, a microprocessor, a controller, a microcontroller, a digital signal processor, a field-programmable gate array, an application-specific integrated circuit, and/or another type of processing component. The processor 920 may be implemented in hardware, firmware, or a combination of hardware and software. In some implementations, the processor 920 may include one or more processors capable of being programmed to perform one or more operations or processes described elsewhere herein.

The memory 930 may include volatile and/or nonvolatile memory. For example, the memory 930 may include random access memory (RAM), read only memory (ROM), a hard disk drive, and/or another type of memory (e.g., a flash memory, a magnetic memory, and/or an optical memory). The memory 930 may include internal memory (e.g., RAM, ROM, or a hard disk drive) and/or removable memory (e.g., removable via a universal serial bus connection). The memory 930 may be a non-transitory computer-readable medium. The memory 930 may store information, one or more instructions, and/or software (e.g., one or more software applications) related to the operation of the device 900. In some implementations, the memory 930 may include one or more memories that are coupled (e.g., communicatively coupled) to one or more processors (e.g., processor 920), such as via the bus 910. Communicative coupling between a processor 920 and a memory 930 may enable the processor 920 to read and/or process information stored in the memory 930 and/or to store information in the memory 930.

The input component 940 may enable the device 900 to receive input, such as user input and/or sensed input. For example, the input component 940 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 950 may enable the device 900 to provide output, such as via a display, a speaker, and/or a light-emitting diode. The communication component 960 may enable the device 900 to communicate with other devices via a wired connection and/or a wireless connection. For example, the communication component 960 may include a receiver, a transmitter, a transceiver, a modem, a network interface card, and/or an antenna.

The device 900 may perform one or more operations or processes described herein. For example, a non-transitory computer-readable medium (e.g., memory 930) may store a set of instructions (e.g., one or more instructions or code) for execution by the processor 920. The processor 920 may execute the set of instructions to perform one or more operations or processes described herein. In some implementations, execution of the set of instructions, by one or more processors 920, causes the one or more processors 920 and/or the device 900 to perform one or more operations or processes described herein. In some implementations, hardwired circuitry may be used instead of or in combination with the instructions to perform one or more operations or processes described herein. Additionally, or alternatively, the processor 920 may be configured to perform one or more operations or processes described herein. Thus, implementations described herein are not limited to any specific combination of hardware circuitry and software.

The number and arrangement of components shown in FIG. 9 are provided as an example. The device 900 may include additional components, fewer components, different components, or differently arranged components than those shown in FIG. 9. Additionally, or alternatively, a set of components (e.g., one or more components) of the device 900 may perform one or more functions described as being performed by another set of components of the device 900.

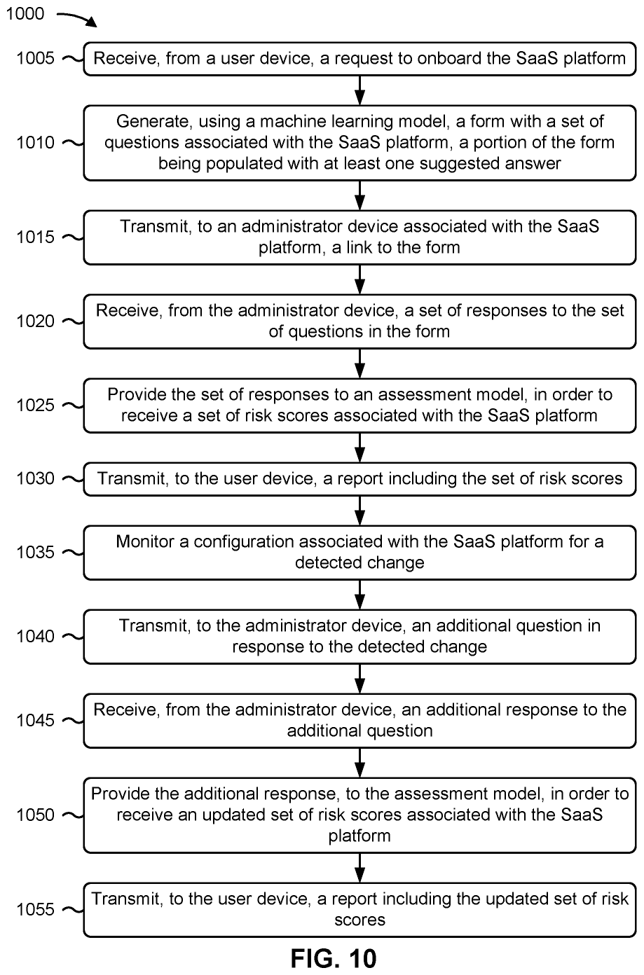

FIG. 10 is a flowchart of an example process 1000 associated with automated assessment of SaaS platforms. In some implementations, one or more process blocks of FIG. 10 may be performed by an assessment system 801. In some implementations, one or more process blocks of FIG. 10 may be performed by another device or a group of devices separate from or including the assessment system 801, such as a user device 830, an administrator device 840, an ML host 850, and/or a SaaS platform 860. Additionally, or alternatively, one or more process blocks of FIG. 10 may be performed by one or more components of the device 900, such as processor 920, memory 930, input component 940, output component 950, and/or communication component 960.

As shown in FIG. 10, process 1000 may include receiving, from a user device, a request to onboard the SaaS platform (block 1005). For example, the assessment system 801 (e.g., using processor 920, memory 930, input component 940, and/or communication component 960) may receive, from a user device, a request to onboard the SaaS platform, as described above in connection with reference number 105 of FIG. 1A. As an example, the request may include an HTTP message and/or a call to an API function (associated with the assessment system 801).

As further shown in FIG. 10, process 1000 may include generating, using a machine learning model, a form with a set of questions associated with the SaaS platform, a portion of the form being populated with at least one suggested answer (block 1010). For example, the assessment system 801 (e.g., using processor 920, memory 930, and/or communication component 960) may generate, using a machine learning model, a form with a set of questions associated with the SaaS platform, a portion of the form being populated with at least one suggested answer, as described above in connection with reference numbers 110 and 115 of FIG. 1A. As an example, the assessment system 801 may transmit a request to an ML host associated with the machine learning model. Accordingly, the assessment system 801 may receive the at least one suggested answer from the ML host and in response to the request. The ML model may be trained on historical information associated with the SaaS platform (e.g., answers previously submitted by a provider of the SaaS platform).

As further shown in FIG. 10, process 1000 may include transmitting, to an administrator device associated with the SaaS platform, a link to the form (block 1015). For example, the assessment system 801 (e.g., using processor 920, memory 930, and/or communication component 960) may transmit, to an administrator device associated with the SaaS platform, a link to the form, as described above in connection with reference number 120 of FIG. 1A. As an example, the assessment system 801 may transmit a message (e.g., a chat message, an email message, a text message, and/or another type of message) including the link to the administrator device. The link may include a hypertext link (e.g., an HTTP link) or another type of string that the administrator device can use to access the form. Accordingly, the form may be hosted remotely from the administrator device (e.g., at the assessment system 801 or at a third-party system).

As further shown in FIG. 10, process 1000 may include receiving, from the administrator device, a set of responses to the set of questions in the form (block 1020). For example, the assessment system 801 (e.g., using processor 920, memory 930, and/or communication component 960) may receive, from the administrator device, a set of responses to the set of questions in the form, as described above in connection with reference number 130 of FIG. 1B. As an example, the assessment system 801 may receive the set of responses directly from the administrator device. Alternatively, a third-party system (e.g., a third-party system hosting the form) may receive the set of responses from the administrator device, and the assessment system 801 may receive the set of responses from the third-party system.

As further shown in FIG. 10, process 1000 may include providing the set of responses to an assessment model, in order to receive a set of risk scores associated with the SaaS platform (block 1025). For example, the assessment system 801 (e.g., using processor 920, memory 930, and/or communication component 960) may provide the set of responses to an assessment model, in order to receive a set of risk scores associated with the SaaS platform, as described above in connection with reference numbers 145 and 150 of FIG. 1C. As an example, the assessment system 801 may transmit a request to an ML host associated with the assessment model. Accordingly, the assessment system 801 may receive the set of risk scores from the ML host and in response to the request. The assessment model may be trained on answers to the set of questions (e.g., associated with other SaaS platforms).

As further shown in FIG. 10, process 1000 may include transmitting, to the user device, a report including the set of risk scores (block 1030). For example, the assessment system 801 (e.g., using processor 920, memory 930, output component 950, and/or communication component 960) may transmit, to the user device, a report including the set of risk scores, as described above in connection with reference number 155 of FIG. 1C. As an example, the report may be output in a UI or in a series of UIs. An example report is described in connection with FIGS. 4A-4B. An additional example report is described in connection with FIGS. 7A-7B.

As further shown in FIG. 10, process 1000 may include monitoring a configuration associated with the SaaS platform for a detected change (block 1035). For example, the assessment system 801 (e.g., using processor 920, memory 930, and/or communication component 960) may monitor a configuration associated with the SaaS platform for a detected change, as described above in connection with reference number 205 of FIG. 2A. As an example, the assessment system 801 may track at least one configuration file, associated with the SaaS platform, for modifications. Additionally, or alternatively, the assessment system 801 may monitor traffic, associated with at least one API of the SaaS platform, to detect traffic pattern changes. Additionally, or alternatively, the assessment system 801 may scan data, received from the SaaS platform, for format changes.

As further shown in FIG. 10, process 1000 may include transmitting, to the administrator device, an additional question in response to the detected change (block 1040). For example, the assessment system 801 (e.g., using processor 920, memory 930, and/or communication component 960) may transmit, to the administrator device, an additional question in response to the detected change, as described above in connection with reference number 210 of FIG. 2A. As an example, the assessment system 801 may add a new question to the form in response to the detected change and may transmit a link, to the form with the new question, to the administrator device. In another example, the assessment system 801 may clear a previous response from the form (in response to the detected change) and may transmit a link, to the form with a blank in place of the previous response, to the administrator device.

As further shown in FIG. 10, process 1000 may include receiving, from the administrator device, an additional response to the additional question (block 1045). For example, the assessment system 801 (e.g., using processor 920, memory 930, and/or communication component 960) may receive, from the administrator device, an additional response to the additional question, as described above in connection with reference number 215 of FIG. 2A. As an example, the assessment system 801 may receive the additional response directly from the administrator device. Alternatively, a third-party system (e.g., a third-party system hosting the form) may receive the additional response from the administrator device, and the assessment system 801 may receive the additional response from the third-party system.

As further shown in FIG. 10, process 1000 may include providing the additional response to the assessment model, in order to receive an updated set of risk scores associated with the SaaS platform (block 1050). For example, the assessment system 801 (e.g., using processor 920, memory 930, and/or communication component 960) may provide the additional response to the assessment model, in order to receive an updated set of risk scores associated with the SaaS platform, as described above in connection with reference numbers 220 and 225 of FIG. 2B. As an example, the assessment system 801 (e.g., using processor 920, memory 930, and/or communication component 960) may provide the set of responses to an assessment model, in order to receive a set of risk scores associated with the SaaS platform, as described above in connection with reference numbers 145 and 150 of FIG. 1C. As an example, the assessment system 801 may transmit a request to an ML host associated with the assessment model. Accordingly, the assessment system 801 may receive the updated set of risk scores from the ML host and in response to the request.

As further shown in FIG. 10, process 1000 may include transmitting, to the user device, a report including the updated set of risk scores (block 1055). For example, the assessment system 801 (e.g., using processor 920, memory 930, and/or communication component 960) may transmit, to the user device, a report including the updated set of risk scores, as described above in connection with reference number 230 of FIG. 2B. As an example, the report may be output in a UI or in a series of UIs. An example report is described in connection with FIGS. 4A-4B. An additional example report is described in connection with FIGS. 7A-7B.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel. The process 1000 is an example of one process that may be performed by one or more devices described herein. These one or more devices may perform one or more other processes based on operations described herein, such as the operations described in connection with FIGS. 1A-1D, 2A-2D, 3A-3B, 4A-4B, 5A-5C, 6A-6C, and/or 7A-7B. Moreover, while the process 1000 has been described in relation to the devices and components of the preceding figures, the process 1000 can be performed using alternative, additional, or fewer devices and/or components. Thus, the process 1000 is not limited to being performed with the example devices, components, hardware, and software explicitly enumerated in the preceding figures.

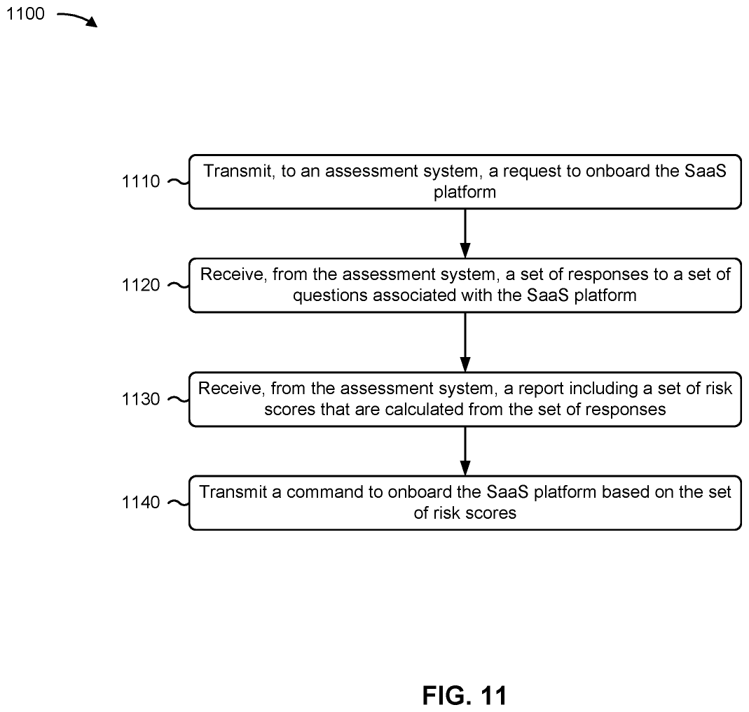

FIG. 11 is a flowchart of an example process 1100 associated with initiating automated assessment of SaaS platforms. In some implementations, one or more process blocks of FIG. 11 may be performed by a user device 830. In some implementations, one or more process blocks of FIG. 11 may be performed by another device or a group of devices separate from or including the user device 830, such as an assessment system 801, an administrator device 840, an ML host 850, and/or a SaaS platform 860. Additionally, or alternatively, one or more process blocks of FIG. 11 may be performed by one or more components of the device 900, such as processor 920, memory 930, input component 940, output component 950, and/or communication component 960.

As shown in FIG. 11, process 1100 may include transmitting, to an assessment system, a request to onboard the SaaS platform (block 1110). For example, the user device 830 (e.g., using processor 920, memory 930, and/or communication component 960) may transmit, to an assessment system, a request to onboard the SaaS platform, as described above in connection with reference number 105 of FIG. 1A. As an example, a user of the user device 830 may provide input (e.g., using an input component 940 of the user device 830) that triggers the user device to transmit the request. The user may interact with a UI to provide the input that triggers the user device 830 to transmit the request. Alternatively, the user may provide the input using a command line or another type of text-based interface.

As further shown in FIG. 11, process 1100 may include receiving, from the assessment system, a set of responses to a set of questions associated with the SaaS platform (block 1120). For example, the user device 830 (e.g., using processor 920, memory 930, and/or communication component 960) may receive, from the assessment system, a set of responses to a set of questions associated with the SaaS platform, as described above in connection with reference number 135 of FIG. 1B. As an example, the user device 830 may output the set of responses (e.g., using an output component 950 of the user device 830) to the user in a UI.

As further shown in FIG. 11, process 1100 may include receiving, from the assessment system, a report including a set of risk scores that are calculated from the set of responses (block 1130). For example, the user device 830 (e.g., using processor 920, memory 930, and/or communication component 960) may receive, from the assessment system, a report including a set of risk scores that are calculated from the set of responses, as described above in connection with reference number 155 of FIG. 1C. As an example, the user device 830 may output the report (e.g., using an output component 950 of the user device 830) to the user in a UI or in a series of UIs. An example report is described in connection with FIGS. 4A-4B. An additional example report is described in connection with FIGS. 7A-7B.

As further shown in FIG. 11, process 1100 may include transmitting a command to onboard the SaaS platform based on the set of risk scores (block 1140). For example, the user device 830 (e.g., using processor 920, memory 930, and/or communication component 960) may transmit a command to onboard the SaaS platform based on the set of risk scores, as described above in connection with reference number 160 of FIG. 1D. As an example, the user may review the set of risk scores and provide input that triggers the user device 830 to transmit the command. Additionally, or alternatively, the user device 830 may automatically transmit the command (e.g., based on the set of risk scores satisfying one or more risk thresholds).

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel. The process 1100 is an example of one process that may be performed by one or more devices described herein. These one or more devices may perform one or more other processes based on operations described herein, such as the operations described in connection with FIGS. 1A-1D, 2A-2D, 3B, 4A-4B, 5A-5C, 6A-6C, and/or 7A-7B. Moreover, while the process 1100 has been described in relation to the devices and components of the preceding figures, the process 1100 can be performed using alternative, additional, or fewer devices and/or components. Thus, the process 1100 is not limited to being performed with the example devices, components, hardware, and software explicitly enumerated in the preceding figures.

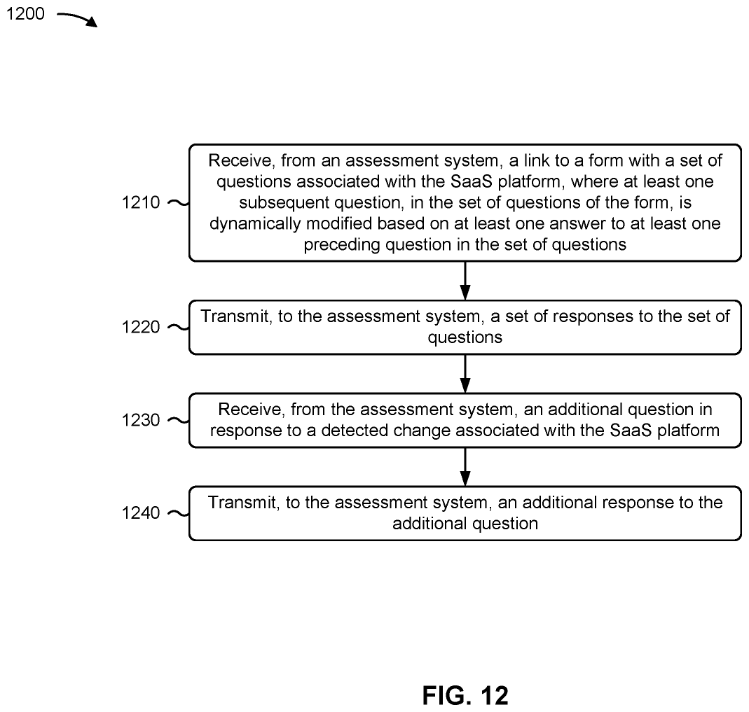

FIG. 12 is a flowchart of an example process 1200 associated with responding for assessment of SaaS platforms. In some implementations, one or more process blocks of FIG. 12 may be performed by an administrator device 840. In some implementations, one or more process blocks of FIG. 12 may be performed by another device or a group of devices separate from or including the administrator device 840, such as an assessment system 801, a user device 830, an ML host 850, and/or a SaaS platform 860. Additionally, or alternatively, one or more process blocks of FIG. 12 may be performed by one or more components of the device 900, such as processor 920, memory 930, input component 940, output component 950, and/or communication component 960.

As shown in FIG. 12, process 1200 may include receiving, from an assessment system, a link to a form with a set of questions associated with the SaaS platform, where at least one subsequent question, in the set of questions of the form, is dynamically modified based on at least one answer to at least one preceding question in the set of questions (block 1210). For example, the administrator device 840 (e.g., using processor 920, memory 930, and/or communication component 960) may receive, from an assessment system, a link to a form with a set of questions associated with the SaaS platform, as described above in connection with reference number 120 of FIG. 1A. As an example, the administrator device 840 may receive a message (e.g., a chat message, an email message, a text message, and/or another type of message) including the link. The link may include a hypertext link (e.g., an HTTP link) or another type of string that the administrator device 840 can use to access the form. As described in connection with reference number 125 of FIG. 1B, the form may be dynamic.

As further shown in FIG. 12, process 1200 may include transmitting, to the assessment system, a set of responses to the set of questions (block 1220). For example, the administrator device 840 (e.g., using processor 920, memory 930, and/or communication component 960) may transmit, to the assessment system, a set of responses to the set of questions, as described above in connection with reference number 130 of FIG. 1B. As an example, an administrator using the administrator device 840 may, before submitting the form, review (and optionally modify) a suggested answer that was included in the form. Additionally, the administrator may insert answers to a portion of the set of questions that lack suggested answers. In other words, the administrator may complete a portion of the set of responses that were not pre-populated.

As further shown in FIG. 12, process 1200 may include receiving, from the assessment system, an additional question in response to a detected change associated with the SaaS platform (block 1230). For example, the administrator device 840 (e.g., using processor 920, memory 930, and/or communication component 960) may receive, from the assessment system, an additional question in response to a detected change associated with the SaaS platform, as described above in connection with reference number 210 of FIG. 2A. As an example, the administrator device 840 may receive a link to the form with a new question in the form. In another example, the administrator device 840 may receive a link to the form with a blank in place of the previous response.

As further shown in FIG. 12, process 1200 may include transmitting, to the assessment system, an additional response to the additional question (block 1240). For example, the administrator device 840 (e.g., using processor 920, memory 930, and/or communication component 960) may transmit, to the assessment system, an additional response to the additional question, as described above in connection with reference number 215 of FIG. 2A. As an example, the administrator may provide input (e.g., using an input component 940 of the administrator device 840) that triggers the administrator device 840 to transmit the additional response. For example, the administrator may interact with a UI to provide the additional response and to provide the input that triggers the administrator device 840 to transmit the additional response.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel. The process 1200 is an example of one process that may be performed by one or more devices described herein. These one or more devices may perform one or more other processes based on operations described herein, such as the operations described in connection with FIGS. 1A-1D, 2A-2D, and/or 3A. Moreover, while the process 1200 has been described in relation to the devices and components of the preceding figures, the process 1200 can be performed using alternative, additional, or fewer devices and/or components. Thus, the process 1200 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a−b, a−c, b−c, and a−b−c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a−b, a−c, b−c, and a−b−c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automatically assessing a software-as-a-service (SaaS) platform, the system comprising:
one or more memories; and
one or more processors, communicatively coupled to the one or more memories, configured to:
receive, from a user device, a request to onboard the SaaS platform;
generate, using a machine learning model, a form with a set of questions associated with the SaaS platform, wherein a portion of the form is populated with at least one suggested answer;
transmit, to an administrator device associated with the SaaS platform, a link to the form;
receive, from the administrator device, a set of responses to the set of questions in the form;
provide the set of responses to an assessment model, in order to receive a set of risk scores associated with the SaaS platform;
transmit, to the user device, a report including the set of risk scores;
monitor a configuration associated with the SaaS platform for a detected change;
transmit, to the administrator device, an additional question in response to the detected change;
receive, from the administrator device, an additional response to the additional question;
provide the additional response to the assessment model, in order to receive an updated set of risk scores associated with the SaaS platform; and
transmit, to the user device, a report including the updated set of risk scores.

2. The system of claim 1, wherein at least one subsequent question, in the set of questions of the form, is dynamically modified based on at least one answer to at least one preceding question in the set of questions.

3. The system of claim 1, wherein the machine learning model is trained using historical responses associated with a provider of the SaaS platform.

4. The system of claim 1, wherein the one or more processors, to generate the form, are configured to:
transmit, to a machine learning host associated with the machine learning model, an indication of the SaaS platform; and
receive, from the machine learning host and in response to the indication of the SaaS platform, an indication of the set of questions for the form.

5. The system of claim 1, wherein the assessment model comprises a set of rules that map answers to risk scores.

6. The system of claim 1, wherein the assessment model comprises an additional machine learning model.

7. The system of claim 1, wherein the one or more processors, to monitor the configuration associated with the SaaS platform, are configured to perform at least one of:
tracking at least one configuration file associated with the SaaS platform for modifications;
monitoring traffic associated with at least one application programming interface of the SaaS platform to detect traffic pattern changes; or
scanning data received from the SaaS platform for format changes.

8. The system of claim 1, wherein the one or more processors are further configured to:
receive, in response to the report including the set of risk scores, an instruction to onboard the SaaS platform; and
transmit, in response to the instruction, a command to connect at least one application to at least one application programming interface of the SaaS platform.

9. The system of claim 1, wherein the one or more processors are further configured to:
receive, in response to the report including the updated set of risk scores, an instruction to authorize the SaaS platform; and
transmit, in response to the instruction, a command to allow the detected change.

10. The system of claim 1, wherein the one or more processors are further configured to:
receive, in response to the report including the updated set of risk scores, an instruction to disable the SaaS platform; and
transmit, in response to the instruction, a command to disconnect at least one application from at least one application programming interface of the SaaS platform.

11. A method of automatically assessing a software-as-a-service (SaaS) platform, comprising:
transmitting, from a user device and to an assessment system, a request to onboard the SaaS platform;
receiving, from the assessment system and at the user device, a set of responses to a set of questions associated with the SaaS platform;
receiving, from the assessment system and at the user device, a report including a set of risk scores, wherein the set of risk scores are calculated from the set of responses; and
transmitting, from the user device, a command to onboard the SaaS platform based on the set of risk scores.

12. The method of claim 11, further comprising:
transmitting, to the assessment system and from the user device, a command to modify the set of responses.

13. The method of claim 11, further comprising:
transmitting, to the assessment system and from the user device, a command to modify the set of risk scores,
wherein the report is generated based on the command to modify the set of risk scores.

14. The method of claim 11, further comprising:
receiving, in response to the command to onboard the SaaS platform, a confirmation that at least one application was connected to at least one application programming interface of the SaaS platform.

15. The method of claim 11, wherein a portion of the set of responses are pre-populated.

16. A non-transitory computer-readable medium storing a set of instructions for automatically assessing a software-as-a-service (SaaS) platform, the set of instructions comprising:
one or more instructions that, when executed by one or more processors of a device, cause the device to:
receive, from an assessment system, a link to a form with a set of questions associated with the SaaS platform, wherein at least one subsequent question, in the set of questions of the form, is dynamically modified based on at least one answer to at least one preceding question in the set of questions;
transmit, to the assessment system, a set of responses to the set of questions;
receive, from the assessment system, an additional question in response to a detected change associated with the SaaS platform; and
transmit, to the assessment system, an additional response to the additional question.

17. The non-transitory computer-readable medium of claim 16, wherein a portion of the form is populated with at least one suggested answer.

18. The non-transitory computer-readable medium of claim 16, wherein the one or more instructions, when executed by the one or more processors, cause the device to:
receive, from the assessment system, a confirmation that the SaaS platform is being onboarded.

19. The non-transitory computer-readable medium of claim 16, wherein the one or more instructions, when executed by the one or more processors, cause the device to:
receive, from the assessment system, a confirmation that the detected change was accepted.

20. The non-transitory computer-readable medium of claim 16, wherein the link comprises a hypertext link.
